(19) United States
(12) Patent Application Publication
(10) Pub. No.: US 2025/0261180 A1
(43) Pub. Date: Aug. 14, 2025

(54) PREDICTIVE BEAM MANAGEMENT FOR CELL GROUP SETUP

(71) Applicant: QUALCOMM Incorporated, San Diego, CA (US)

(72) Inventors: Qiaoyu LI, Beijing (CN); Mahmoud TAHERZADEH BOROUJENI, San Diego, CA (US); Tao LUO, San Diego, CA (US); Jelena DAMNJANOVIC, Del Mar, CA (US); Ruiming ZHENG, Beijing (CN)

(21) Appl. No.: 18/856,513

(22) PCT Filed: Jun. 16, 2022
(86) PCT No.: PCT/CN2022/099076

§ 371 Date: Oct. 11, 2024

(51) Int. Cl. H04W 72/044; H04W 24/10; H04W 72/542; H04W 74/0833

(52) U.S. Cl. CPC H04W 72/046; H04W 24/10; H04W 72/542; H04W 74/0833

(57) ABSTRACT

Disclosed are systems and techniques for wireless communications. For instance, a user equipment (UE) can obtain one or more channel measurements corresponding to a first beam received from a first network entity. In some cases, the UE can determine, based on the one or more channel measurements, one or more parameters corresponding to a second network entity. In some examples, the UE can transmit, based on the one or more parameters, an uplink signal to the second network entity.

### CROSS-REFERENCE TO RELATED APPLICATIONS

This application for patent is a 371 of international Patent Application PCT/CN2022/099076, filed Jun. 16, 2022, which is hereby incorporated by referenced in its entirety and for all purposes.

### FIELD OF THE DISCLOSURE

The present disclosure generally relates to wireless communications. For example, aspects of the present disclosure relate to systems and techniques for implementing predictive beam management for cell group setup (e.g., for secondary cell group (SCG) setup).

### BACKGROUND OF THE DISCLOSURE

Wireless communications systems are deployed to provide various telecommunications and data services, including telephony, video, data, messaging, and broadcasts. Broadband wireless communications systems have developed through various generations, including a first-generation analog wireless phone service (1G), a second-generation (2G) digital wireless phone service (including interim 2.5G networks), a third-generation (3G) high speed data, Internet-capable wireless device, and a fourth-generation (4G) service (e.g., Long-Term Evolution (LTE), WiMax). Examples of wireless communications systems include code division multiple access (CDMA) systems, time division multiple access (TDMA) systems, frequency division multiple access (FDMA) systems, orthogonal frequency division multiple access (OFDMA) systems, Global System for Mobile communication (GSM) systems, etc. Other wireless communications technologies include 802.11 Wi-Fi, Bluetooth, among others.

A fifth-generation (5G) mobile standard calls for higher data transfer speeds, greater number of connections, and better coverage, among other improvements. The 5G standard (also referred to as “New Radio” or “NR”), according to Next Generation Mobile Networks Alliance, is designed to provide data rates of several tens of megabits per second to each of tens of thousands of users, with 1 gigabit per second to tens of workers on an office floor. Several hundreds of thousands of simultaneous connections should be supported in order to support large sensor deployments. Consequently, the spectral efficiency of 5G mobile communications should be significantly enhanced compared to the current 4G/LTE standard. Furthermore, signaling efficiencies should be enhanced and latency should be substantially reduced compared to current standards.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary presents certain concepts relating to one or more aspects relating to the mechanisms disclosed herein in a simplified form to precede the detailed description presented below.

Disclosed are systems, methods, apparatuses, and computer-readable media for performing wireless communications. An access link can be established between a user equipment (UE) and one or more base stations (e.g., a 3GPP gNodeB (gNB) for 5G/NR, a 3GPP eNodeB (eNB) for LTE, or a portion thereof) using transmission and reception beams that are aligned with one another. For instance, the UE may detect the best beam (e.g., based on signal strength) among a plurality of transmitted beams from a base station. In some cases, a UE may be associated with one or more serving cells associated with the one or more base stations. In some examples, a UE that is associated with a first serving cell in a master cell group (MCG) may perform additional beam measurements in order to associate with a second serving cell in a secondary cell group (SCG). In some cases, one or more information elements (IEs) can be used to provide dedicated signaling for configuring a UE with an additional cell group. For instance, the IE may include random access channel (RACH) configurations for a UE to initially access a secondary serving cell of an MCG or SCG. In some examples, a UE implementing the RACH procedure for SCG setup may consume excess power and/or incur undue latency as a result of measuring a large number of beams and/or performing beam management in order to establish an access link with the secondary serving cell.

As described in more detail herein, systems and techniques are described herein for performing predictive beam management for secondary cell group (SCG) setup. In some aspects, the systems and techniques may associate one or more resources or beams (e.g., synchronization signal block (SSB) resources or beams, channel state information reference signal (CSI-RS) resources or beams, etc.) in a first serving cell with corresponding resources or beams (e.g., SSB resources, CSI-RS resources, etc.) in a second serving cell. In some cases, the systems and techniques can provide one or more linkage schemes that associate the one or more resources or beams in the first serving cell with the corresponding resources or beams in the second serving cell.

In some aspects, a user equipment (UE) can perform channel measurements of the beams (e.g., SSB beams, CSI-RS beams, etc.) transmitted by the first serving cell. For instance, the first serving cell may be associated with the UE in a master cell group (MCG). In some cases, the channel measurements can include reference signal received power (RSRP), received signal strength indicator (RSSI), reference signal quality (RSRQ), channel quality indicator (CQI), power delay profile (PDP), angle of arrival (AoA), angle of departure (AoD), angular spread, explicit time/frequency domain channel characteristics, Eigen vector(s) associated with the channel in the frequency domain, any combination thereof, and/or any other channel measurements.

In some aspects, the UE can use linkage schemes to associate the channel measurements obtained from the first serving cell with one or more parameters corresponding to a second serving cell. In some cases, the parameters corresponding to the second serving cell may include one or more preferred indices or resource identifiers (e.g., one or more preferred SSB indices and/or CSI-RS resource identifiers). In some examples, the parameters corresponding to the second serving cell may include channel parameters such as AoA, AoD, angular spread, etc. In some cases, a UE may use the linkage scheme to identify one or more beams (e.g., SSB beams or CSI-RS beams) for communicating with the secondary serving cell. For example, the UE may transmit, based on the one or more parameters, an uplink signal to the second serving cell. In one illustrative example, the uplink signal can include a RACH message. For instance, the UE may initiate the RACH procedure by transmitting a RACH message (e.g., a random access request message, such as a Message 1 or Message A) to the secondary serving cell using the selected beam.

In one illustrative example, a method for wireless communications performed at a user equipment (UE) is provided. The method includes: obtaining one or more channel measurements corresponding to a first beam received from a first serving cell; determining, based on the one or more channel measurements, one or more parameters corresponding to a second serving cell; and transmitting, based on the one or more parameters, an uplink signal to the second serving cell.

In another example, an apparatus for wireless communication is provided that includes at least one memory comprising instructions and at least one processor (e.g., implemented in circuitry) configured to execute the instructions and cause the apparatus to: obtain one or more channel measurements corresponding to a first beam received from a first serving cell; determine, based on the one or more channel measurements, one or more parameters corresponding to a second serving cell; and transmit, based on the one or more parameters, an uplink signal to the second serving cell.

In another example, a non-transitory computer-readable medium is provided for performing wireless communications, which has stored thereon instructions that, when executed by one or more processors, cause the one or more processors to: obtain one or more channel measurements corresponding to a first beam received from a first serving cell; determine, based on the one or more channel measurements, one or more parameters corresponding to a second serving cell; and transmit, based on the one or more parameters, an uplink signal to the second serving cell.

In another example, an apparatus for wireless communications is provided. The apparatus includes: means for obtaining one or more channel measurements corresponding to a first beam received from a first serving cell; means for determining, based on the one or more channel measurements, one or more parameters corresponding to a second serving cell; and means for transmitting, based on the one or more parameters, an uplink signal to the second serving cell.

In another example, a method for wireless communications performed at a network entity is provided. The method includes: receiving, from a user equipment (UE), one or more channel characteristics corresponding to one or more beams associated with a serving cell; determining, based on the one or more channel characteristics, one or more parameters for configuring the UE to communicate with the serving cell; and transmitting the one or more parameters to the UE.

In another example, an apparatus for wireless communication is provided that includes at least one memory comprising instructions and at least one processor (e.g., implemented in circuitry) configured to execute the instructions and cause the apparatus to: receive, from a user equipment (UE), one or more channel characteristics corresponding to one or more beams associated with a serving cell; determine, based on the one or more channel characteristics, one or more parameters for configuring the UE to communicate with the serving cell; and transmit the one or more parameters to the UE.

In another example, a non-transitory computer-readable medium is provided for performing wireless communications, which has stored thereon instructions that, when executed by one or more processors, cause the one or more processors to: receive, from a user equipment (UE), one or more channel characteristics corresponding to one or more beams associated with a serving cell; determine, based on the one or more channel characteristics, one or more parameters for configuring the UE to communicate with the serving cell; and transmit the one or more parameters to the UE.

In another example, an apparatus for wireless communications is provided. The apparatus includes: means for receiving, from a user equipment (UE), one or more channel characteristics corresponding to one or more beams associated with a serving cell; means for determining, based on the one or more channel characteristics, one or more parameters for configuring the UE to communicate with the serving cell; and means for transmitting the one or more parameters to the UE.

In some aspects, the apparatus is or is part of a base station (e.g., a 3GPP gNodeB (gNB) for 5G/NR, a 3GPP eNodeB (eNB) for LTE, a central unit (CU), a distributed unit (DU), a radio unit (RU), a Near-Real Time (Near-RT) RAN Intelligent Controller (RIC), or a Non-Real Time (Non-RT) RIC, a Wi-Fi access point (AP), or other base station). In some aspects, the apparatus includes a transceiver configured to transmit and/or receive radio frequency (RF) signals. In some aspects, the processor includes a neural processing unit (NPU), a central processing unit (CPU), a graphics processing unit (GPU), or other processing device or component.

Other objects and advantages associated with the aspects disclosed herein will be apparent to those skilled in the art based on the accompanying drawings and detailed description.

### BRIEF DESCRIPTION OF THE DRAWINGS

The accompanying drawings are presented to aid in the description of various aspects of the disclosure and are provided for illustration of the aspects and not limitation thereof.

FIG. 1 is a block diagram illustrating an example of a wireless communication network, in accordance with some examples;

FIG. 2 is a diagram illustrating a design of a base station and a User Equipment (UE) device that enable transmission and processing of signals exchanged between the UE and the base station, in accordance with some examples;

FIG. 3 is a diagram illustrating an example of a disaggregated base station, in accordance with some examples;

FIG. 4 is a block diagram illustrating components of a user equipment, in accordance with some examples;

FIG. 5 is a diagram illustrating an example machine learning model, in accordance with some examples;

FIG. 6 is a flow chart illustrating an example of a process of training a machine learning algorithm, in accordance with some examples;

FIG. 7 is a block diagram illustrating another example of a wireless communication network, in accordance with some examples;

FIG. 8 is a sequence diagram illustrating an example for performing predictive beam management for secondary cell group (SCG) setup, in accordance with some examples;

FIG. 9 is another sequence diagram illustrating an example for performing predictive beam management for SCG setup, in accordance with some examples;

FIG. 10 is another sequence diagram illustrating an example for performing predictive beam management for SCG setup, in accordance with some examples;

FIG. 11 is another sequence diagram illustrating an example for performing predictive beam management for SCG setup, in accordance with some examples;

FIG. 12 is a flow diagram illustrating an example of a process for performing predictive beam management SCG setup, in accordance with some examples;

FIG. 13 is a flow diagram illustrating an example of a process for performing predictive beam management SCG setup, in accordance with some examples; and

FIG. 14 is a block diagram illustrating an example of a computing system, in accordance with some examples.

### DETAILED DESCRIPTION

Certain aspects and embodiments of this disclosure are provided below for illustration purposes. Alternate aspects may be devised without departing from the scope of the disclosure. Additionally, well-known elements of the disclosure will not be described in detail or will be omitted so as not to obscure the relevant details of the disclosure. Some of the aspects and embodiments described herein may be applied independently and some of them may be applied in combination as would be apparent to those of skill in the art. In the following description, for the purposes of explanation, specific details are set forth in order to provide a thorough understanding of embodiments of the application. However, it will be apparent that various embodiments may be practiced without these specific details. The figures and description are not intended to be restrictive.

The ensuing description provides example embodiments, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the scope of the application as set forth in the appended claims.

Wireless communication networks are deployed to provide various communication services, such as voice, video, packet data, messaging, broadcast, and the like. A wireless communication network may support both access links and sidelinks for communication between wireless devices. An access link may refer to any communication link between a client device (e.g., a user equipment (UE), a station (STA), or other client device) and a base station (e.g., a 3GPP gNodeB (gNB) for 5G/NR, a 3GPP eNodeB (eNB) for LTE, a Wi-Fi access point (AP), or other base station) or a component of a disaggregated base station (e.g., a central unit, a distributed unit, and/or a radio unit). In one example, an access link between a UE and a 3GPP gNB can be over a Uu interface. In some cases, an access link may support uplink signaling, downlink signaling, connection procedures, etc.

In some aspects, an access link between a UE and a gNB can be established using transmission and reception beams that are aligned with one another. For example, a gNB may transmit a sequence of synchronization signal block (SSB) beams or channel state information reference signal (CSI-RS) beams in different directions and a UE may detect the best beam (e.g., based on signal strength) among the transmitted beams. In some cases, the UE may transmit a physical random access channel (PRACH) transmission to the gNB based on the location that is mapped to the SSB beam identifier or the CSI-RS beam resource identifier.

In some examples, a UE that is associated with a first serving cell in a master cell group (MCG) may perform additional beam measurements in order to associate with a second serving cell in a secondary cell group (SCG). For example, an information element (IE) such as ServingCellConfigCommon can be used to provide dedicated signaling for configuring a UE with an additional cell group. In some aspects, the IE may include random access channel (RACH) configurations for a UE to initially access a secondary serving cell. In some cases, the UE measures SSB beams associated with the secondary serving cell and performs RACH procedures using contention-based random access (CBRA) (e.g., based on RACH-ConfigCommon) or using contention-free random access (CFRA) (e.g., based on RACH-ConfigDedicated).

In some cases, a UE implementing the RACH procedure for SCG setup may consume excess power and/or incur undue latency as a result of measuring a large number of beams (e.g., SSB beams) and/or performing beam management (e.g., beam selection (P1); TX beam refinement (P2); and RX beam refinement (P3)) in order to establish an access link with the secondary serving cell.

Systems, apparatuses, processes (also referred to as methods), and computer-readable media (collectively referred to as “systems and techniques”) are described herein for performing predictive beam management for secondary cell group (SCG) setup. In some aspects, the systems and techniques may associate (e.g., using one or more linkage schemes) synchronization signal block (SSB) resources and/or channel state information reference signal (CSI-RS) resources in a first serving cell with SSB and/or CSI-RS resources in a second serving cell.

In some aspects, a user equipment (UE) can perform channel measurements of the SSB beams and/or CSI-RS beams transmitted by the first serving cell (e.g., serving cell associated with UE in master cell group). In some cases, the channel measurements can include reference signal received power (RSRP), received signal strength indicator (RSSI), reference signal quality (RSRQ), channel quality indicator (CQI), power delay profile (PDP), angle of arrival (AoA), angle of departure (AoD), angular spread, explicit time/frequency domain channel characteristics, Eigen vector(s) associated with the channel in the frequency domain, any combination thereof, and/or any other channel measurements.

In some examples, the UE can use linkage schemes to associate the channel measurements obtained from the first serving cell with one or more parameters corresponding to a second serving cell. In some cases, the linkage schemes may be explicitly configured on the UE (e.g., a table or function that maps measurements from the first serving cell to parameters corresponding to the second serving cell). In some examples, the linkage schemes may be implemented using one or more machine learning algorithms. For example, a machine learning model can receive input that includes one or more channel measurements from a first serving cell and provide an output that includes one or more parameters corresponding to a second serving cell. In some cases, the parameters corresponding to the second serving cell may include one or more preferred SSB indices and/or CSI-RS resource identifiers. In some examples, the parameters corresponding to the second serving cell may include channel parameters such as AoA, AoD, angular spread, etc.

In some cases, the UE may use the linkage scheme to identify one or more SSB beams or CSI-RS beams for communicating with the secondary serving cell. For example, the UE may transmit, based on the one or more parameters, an uplink signal to the secondary serving cell. In one illustrative example, the uplink signal can include a RACH message. For instance, the UE may initiate the RACH procedure by transmitting a RACH message (e.g., a random access request message, such as a Message 1 or Message A) to the secondary serving cell using the selected beam.

In some aspects, the UE may transmit a feedback message to the first serving cell. In some examples, the feedback message may include one or more of the channel measurements obtained by the UE from the first serving cell. In some cases, the feedback message may include one or more parameters corresponding to the second serving cell. In some examples, the primary serving cell may also be configured to implement one or more linkage schemes. For example, the primary serving cell may use data received in the feedback message to determine one or more parameters associated with the secondary serving cell. In some cases, the first serving cell may identify multiple beams (e.g., multiple SSB indices and/or multiple CSI-RS resource identifiers) for the UE to communicate with the second serving cell. In some examples, the first serving cell may identify a single preferred beam (e.g., a preferred SSB index and/or a preferred CSI-RS resource identifier) for the UE to communicate with the second serving cell.

In some cases, the first serving cell can transmit an indication to the UE that identifies the multiple beams and/or the preferred beam. In some examples, the UE may perform additional channel measurements on the multiple beams from the second serving cell in order to identify a preferred beam. In some instances, the UE may use the preferred beam (e.g., identified through measurements or via indication from the first serving cell) to communicate with the second serving cell. In some examples, the UE may bypass RACH procedures and communicate with the second serving cell using physical uplink shared channel (PUSCH) transmissions.

As used herein, the terms “user equipment” (UE) and “network entity” are not intended to be specific or otherwise limited to any particular radio access technology (RAT), unless otherwise noted. In general, a UE may be any wireless communication device (e.g., a mobile phone, router, tablet computer, laptop computer, and/or tracking device, etc.), wearable (e.g., smartwatch, smart-glasses, wearable ring, and/or an extended reality (XR) device such as a virtual reality (VR) headset, an augmented reality (AR) headset or glasses, or a mixed reality (MR) headset), vehicle (e.g., automobile, motorcycle, bicycle, etc.), and/or Internet of Things (IoT) device, etc., used by a user to communicate over a wireless communications network. A UE may be mobile or may (e.g., at certain times) be stationary, and may communicate with a radio access network (RAN). As used herein, the term “UE” may be referred to interchangeably as an “access terminal” or “AT,” a “client device,” a “wireless device,” a “subscriber device,” a “subscriber terminal,” a “subscriber station,” a “user terminal” or “UT,” a “mobile device,” a “mobile terminal,” a “mobile station,” or variations thereof. Generally, UEs can communicate with a core network via a RAN, and through the core network the UEs can be connected with external networks such as the Internet and with other UEs. Of course, other mechanisms of connecting to the core network and/or the Internet are also possible for the UEs, such as over wired access networks, wireless local area network (WLAN) networks (e.g., based on IEEE 802.11 communication standards, etc.) and so on.

A network entity can be implemented in an aggregated or monolithic base station architecture, or alternatively, in a disaggregated base station architecture, and may include one or more of a central unit (CU), a distributed unit (DU), a radio unit (RU), a Near-Real Time (Near-RT) RAN Intelligent Controller (RIC), or a Non-Real Time (Non-RT) RIC. A base station (e.g., with an aggregated/monolithic base station architecture or disaggregated base station architecture) may operate according to one of several RATs in communication with UEs depending on the network in which it is deployed, and may be alternatively referred to as an access point (AP), a network node, a NodeB (NB), an evolved NodeB (eNB), a next generation eNB (ng-eNB), a New Radio (NR) Node B (also referred to as a gNB or gNodeB), etc. A base station may be used primarily to support wireless access by UEs, including supporting data, voice, and/or signaling connections for the supported UEs. In some systems, a base station may provide edge node signaling functions while in other systems it may provide additional control and/or network management functions. A communication link through which UEs can send signals to a base station is called an uplink (UL) channel (e.g., a reverse traffic channel, a reverse control channel, an access channel, etc.). A communication link through which the base station can send signals to UEs is called a downlink (DL) or forward link channel (e.g., a paging channel, a control channel, a broadcast channel, or a forward traffic channel, etc.). The term traffic channel (TCH), as used herein, can refer to either an uplink, reverse or downlink, and/or a forward traffic channel.

The term “network entity” or “base station” (e.g., with an aggregated/monolithic base station architecture or disaggregated base station architecture) may refer to a single physical transmit receive point (TRP) or to multiple physical TRPs that may or may not be co-located. For example, where the term “network entity” or “base station” refers to a single physical TRP, the physical TRP may be an antenna of the base station corresponding to a cell (or several cell sectors) of the base station. Where the term “network entity” or “base station” refers to multiple co-located physical TRPs, the physical TRPs may be an array of antennas (e.g., as in a multiple-input multiple-output (MIMO) system or where the base station employs beamforming) of the base station. Where the term “base station” refers to multiple non-co-located physical TRPs, the physical TRPs may be a distributed antenna system (DAS) (a network of spatially separated antennas connected to a common source via a transport medium) or a remote radio head (RRH) (a remote base station connected to a serving base station). Alternatively, the non-co-located physical TRPs may be the serving base station receiving the measurement report from the UE and a neighbor base station whose reference radio frequency (RF) signals (or simply “reference signals”) the UE is measuring. Because a TRP is the point from which a base station transmits and receives wireless signals, as used herein, references to transmission from or reception at a base station are to be understood as referring to a particular TRP of the base station.

In some implementations that support positioning of UEs, a network entity or base station may not support wireless access by UEs (e.g., may not support data, voice, and/or signaling connections for UEs), but may instead transmit reference signals to UEs to be measured by the UEs, and/or may receive and measure signals transmitted by the UEs. Such a base station may be referred to as a positioning beacon (e.g., when transmitting signals to UEs) and/or as a location measurement unit (e.g., when receiving and measuring signals from UEs).

An RF signal comprises an electromagnetic wave of a given frequency that transports information through the space between a transmitter and a receiver. As used herein, a transmitter may transmit a single “RF signal” or multiple “RF signals” to a receiver. However, the receiver may receive multiple “RF signals” corresponding to each transmitted RF signal due to the propagation characteristics of RF signals through multipath channels. The same transmitted RF signal on different paths between the transmitter and receiver may be referred to as a “multipath” RF signal. As used herein, an RF signal may also be referred to as a “wireless signal” or simply a “signal” where it is clear from the context that the term “signal” refers to a wireless signal or an RF signal. In some aspects, an apparatus (e.g., network entity, base station, UE, wireless device, etc.) implementing the systems and techniques described herein may receive (e.g., obtain, collect, get, acquire, etc.) information or data in addition to or as an alternative to receiving an RF signal. In some cases, an apparatus (e.g., network entity, base station, UE, wireless device, etc.) implementing the systems and techniques described herein may transmit (e.g., output, transfer, send, communicate, convey, etc.) information or data in addition to or as an alternative to transmitting an RF signal.

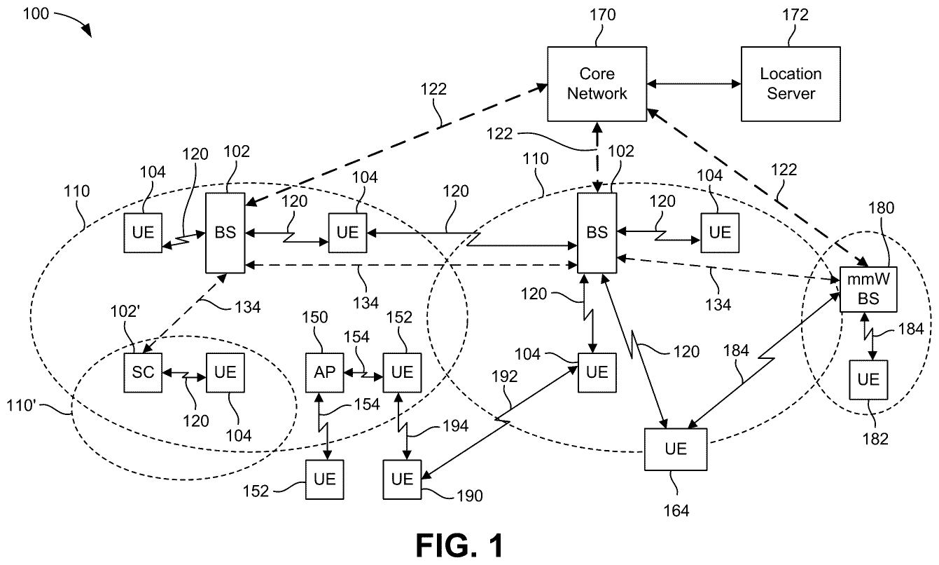

Various aspects of the systems and techniques described herein will be discussed below with respect to the figures. According to various aspects, FIG. 1 illustrates an example of a wireless communications system 100. The wireless communications system 100 (which may also be referred to as a wireless wide area network (WWAN)) can include various base stations 102 and various UEs 104. In some aspects, the base stations 102 may also be referred to as “network entities” or “network nodes.” One or more of the base stations 102 can be implemented in an aggregated or monolithic base station architecture. Additionally, or alternatively, one or more of the base stations 102 can be implemented in a disaggregated base station architecture, and may include one or more of a central unit (CU), a distributed unit (DU), a radio unit (RU), a Near-Real Time (Near-RT) RAN Intelligent Controller (RIC), or a Non-Real Time (Non-RT) RIC. The base stations 102 can include macro cell base stations (high power cellular base stations) and/or small cell base stations (low power cellular base stations). In an aspect, the macro cell base station may include eNBs and/or ng-eNBs where the wireless communications system 100 corresponds to a long term evolution (LTE) network, or gNBs where the wireless communications system 100 corresponds to a NR network, or a combination of both, and the small cell base stations may include femtocells, picocells, microcells, etc.

The base stations 102 may collectively form a RAN and interface with a core network 170 (e.g., an evolved packet core (EPC) or a 5G core (5GC)) through backhaul links 122, and through the core network 170 to one or more location servers 172 (which may be part of core network 170 or may be external to core network 170). In addition to other functions, the base stations 102 may perform functions that relate to one or more of transferring user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, RAN sharing, multimedia broadcast multicast service (MBMS), subscriber and equipment trace, RAN information management (RIM), paging, positioning, and delivery of warning messages. The base stations 102 may communicate with each other directly or indirectly (e.g., through the EPC or 5GC) over backhaul links 134, which may be wired and/or wireless.

The base stations 102 may wirelessly communicate with the UEs 104. Each of the base stations 102 may provide communication coverage for a respective geographic coverage area 110. In an aspect, one or more cells may be supported by a base station 102 in each coverage area 110. A “cell” is a logical communication entity used for communication with a base station (e.g., over some frequency resource, referred to as a carrier frequency, component carrier, carrier, band, or the like), and may be associated with an identifier (e.g., a physical cell identifier (PCI), a virtual cell identifier (VCI), a cell global identifier (CGI)) for distinguishing cells operating via the same or a different carrier frequency. In some cases, different cells may be configured according to different protocol types (e.g., machine-type communication (MTC), narrowband IoT (NB-IoT), enhanced mobile broadband (eMBB), or others) that may provide access for different types of UEs. Because a cell is supported by a specific base station, the term “cell” may refer to either or both of the logical communication entity and the base station that supports it, depending on the context. In addition, because a TRP is typically the physical transmission point of a cell, the terms “cell” and “TRP” may be used interchangeably. In some cases, the term “cell” may also refer to a geographic coverage area of a base station (e.g., a sector), insofar as a carrier frequency can be detected and used for communication within some portion of geographic coverage areas 110.

While neighboring macro cell base station 102 geographic coverage areas 110 may partially overlap (e.g., in a handover region), some of the geographic coverage areas 110 may be substantially overlapped by a larger geographic coverage area 110. For example, a small cell base station 102′ may have a coverage area 110′ that substantially overlaps with the coverage area 110 of one or more macro cell base stations 102. A network that includes both small cell and macro cell base stations may be known as a heterogeneous network. A heterogeneous network may also include home eNBs (HeNBs), which may provide service to a restricted group known as a closed subscriber group (CSG).

The communication links 120 between the base stations 102 and the UEs 104 may include uplink (also referred to as reverse link) transmissions from a UE 104 to a base station 102 and/or downlink (also referred to as forward link) transmissions from a base station 102 to a UE 104. The communication links 120 may use MIMO antenna technology, including spatial multiplexing, beamforming, and/or transmit diversity. The communication links 120 may be through one or more carrier frequencies. Allocation of carriers may be asymmetric with respect to downlink and uplink (e.g., more or less carriers may be allocated for downlink than for uplink).

The wireless communications system 100 may further include a WLAN AP 150 in communication with WLAN stations (STAs) 152 via communication links 154 in an unlicensed frequency spectrum (e.g., 5 Gigahertz (GHz)). When communicating in an unlicensed frequency spectrum, the WLAN STAs 152 and/or the WLAN AP 150 may perform a clear channel assessment (CCA) or listen before talk (LBT) procedure prior to communicating in order to determine whether the channel is available. In some examples, the wireless communications system 100 can include devices (e.g., UEs, etc.) that communicate with one or more UEs 104, base stations 102, APs 150, etc. utilizing the ultra-wideband (UWB) spectrum. The UWB spectrum can range from 3.1 to 10.5 GHz.

The small cell base station 102′ may operate in a licensed and/or an unlicensed frequency spectrum. When operating in an unlicensed frequency spectrum, the small cell base station 102′ may employ LTE or NR technology and use the same 5 GHz unlicensed frequency spectrum as used by the WLAN AP 150. The small cell base station 102′, employing LTE and/or 5G in an unlicensed frequency spectrum, may boost coverage to and/or increase capacity of the access network. NR in unlicensed spectrum may be referred to as NR-U. LTE in an unlicensed spectrum may be referred to as LTE-U, licensed assisted access (LAA), or MulteFire.

The wireless communications system 100 may further include a millimeter wave (mmW) base station 180 that may operate in mmW frequencies and/or near mmW frequencies in communication with a UE 182. The mmW base station 180 may be implemented in an aggregated or monolithic base station architecture, or alternatively, in a disaggregated base station architecture (e.g., including one or more of a CU, a DU, a RU, a Near-RT RIC, or a Non-RT RIC). Extremely high frequency (EHF) is part of the RF in the electromagnetic spectrum. EHF has a range of 30 GHz to 300 GHz and a wavelength between 1 millimeter and 10 millimeters. Radio waves in this band may be referred to as a millimeter wave. Near mmW may extend down to a frequency of 3 GHZ with a wavelength of 100 millimeters. The super high frequency (SHF) band extends between 3 GHz and 30 GHz, also referred to as centimeter wave. Communications using the mmW and/or near mmW radio frequency band have high path loss and a relatively short range. The mmW base station 180 and the UE 182 may utilize beamforming (transmit and/or receive) over an mmW communication link 184 to compensate for the extremely high path loss and short range. Further, it will be appreciated that in alternative configurations, one or more base stations 102 may also transmit using mmW or near mmW and beamforming. Accordingly, it will be appreciated that the foregoing illustrations are merely examples and should not be construed to limit the various aspects disclosed herein.

In some aspects relating to 5G, the frequency spectrum in which wireless network nodes or entities (e.g., base stations 102/180, UEs 104/182) operate is divided into multiple frequency ranges, FRI (from 450 to 6000 Megahertz (MHz)), FR2 (from 24250 to 52600 MHZ), FR3 (above 52600 MHZ), and FR4 (between FR1 and FR2). In a multi-carrier system, such as 5G, one of the carrier frequencies is referred to as the “primary carrier” or “anchor carrier” or “primary serving cell” or “PCell,” and the remaining carrier frequencies are referred to as “secondary carriers” or “secondary serving cells” or “SCells.” In carrier aggregation, the anchor carrier is the carrier operating on the primary frequency (e.g., FR1) utilized by a UE 104/182 and the cell in which the UE 104/182 either performs the initial radio resource control (RRC) connection establishment procedure or initiates the RRC connection re-establishment procedure. The primary carrier carries all common and UE-specific control channels and may be a carrier in a licensed frequency (however, this is not always the case). A secondary carrier is a carrier operating on a second frequency (e.g., FR2) that may be configured once the RRC connection is established between the UE 104 and the anchor carrier and that may be used to provide additional radio resources. In some cases, the secondary carrier may be a carrier in an unlicensed frequency. The secondary carrier may contain only necessary signaling information and signals, for example, those that are UE-specific may not be present in the secondary carrier, since both primary uplink and downlink carriers are typically UE-specific. This means that different UEs 104/182 in a cell may have different downlink primary carriers. The same is true for the uplink primary carriers. The network is able to change the primary carrier of any UE 104/182 at any time. This is done, for example, to balance the load on different carriers. Because a “serving cell” (whether a PCell or an SCell) corresponds to a carrier frequency and/or component carrier over which some base station is communicating, the term “cell,” “serving cell,” “component carrier,” “carrier frequency,” and the like can be used interchangeably.

For example, still referring to FIG. 1, one of the frequencies utilized by the macro cell base stations 102 may be an anchor carrier (or “PCell”) and other frequencies utilized by the macro cell base stations 102 and/or the mmW base station 180 may be secondary carriers (“SCells”). In carrier aggregation, the base stations 102 and/or the UEs 104 may use spectrum up to Y MHz (e.g., 5, 10, 15, 20, 100 MHz) bandwidth per carrier up to a total of Yx MHz (x component carriers) for transmission in each direction. The component carriers may or may not be adjacent to each other on the frequency spectrum. Allocation of carriers may be asymmetric with respect to the downlink and uplink (e.g., more or less carriers may be allocated for downlink than for uplink). The simultaneous transmission and/or reception of multiple carriers enables the UE 104/182 to significantly increase its data transmission and/or reception rates. For example, two 20 MHz aggregated carriers in a multi-carrier system would theoretically lead to a two-fold increase in data rate (i.e., 40 MHz), compared to that attained by a single 20 MHz carrier.

In order to operate on multiple carrier frequencies, a base station 102 and/or a UE 104 can be equipped with multiple receivers and/or transmitters. For example, a UE 104 may have two receivers, “Receiver 1” and “Receiver 2,” where “Receiver 1” is a multi-band receiver that can be tuned to band (i.e., carrier frequency) ‘X’ or band ‘Y,’ and “Receiver 2” is a one-band receiver tuneable to band ‘Z’ only. In this example, if the UE 104 is being served in band ‘X,’ band ‘X’ would be referred to as the PCell or the active carrier frequency, and “Receiver 1” would need to tune from band ‘X’ to band ‘Y’ (an SCell) in order to measure band ‘Y’ (and vice versa). In contrast, whether the UE 104 is being served in band ‘X’ or band ‘Y,’ because of the separate “Receiver 2,” the UE 104 can measure band ‘Z’ without interrupting the service on band ‘X’ or band ‘Y.’

The wireless communications system 100 may further include a UE 164 that may communicate with a macro cell base station 102 over a communication link 120 and/or the mmW base station 180 over an mmW communication link 184. For example, the macro cell base station 102 may support a PCell and one or more SCells for the UE 164 and the mmW base station 180 may support one or more SCells for the UE 164.

The wireless communications system 100 may further include one or more UEs, such as UE 190, that connects indirectly to one or more communication networks via one or more device-to-device (D2D) peer-to-peer (P2P) links (referred to as “sidelinks”). In the example of FIG. 1, UE 190 has a D2D P2P link 192 with one of the UEs 104 connected to one of the base stations 102 (e.g., through which UE 190 may indirectly obtain cellular connectivity) and a D2D P2P link 194 with WLAN STA 152 connected to the WLAN AP 150 (through which UE 190 may indirectly obtain WLAN-based Internet connectivity). In an example, the D2D P2P links 192 and 194 may be supported with any well-known D2D RAT, such as LTE Direct (LTE-D), Wi-Fi Direct (Wi-Fi-D), Bluetooth®, and so on.

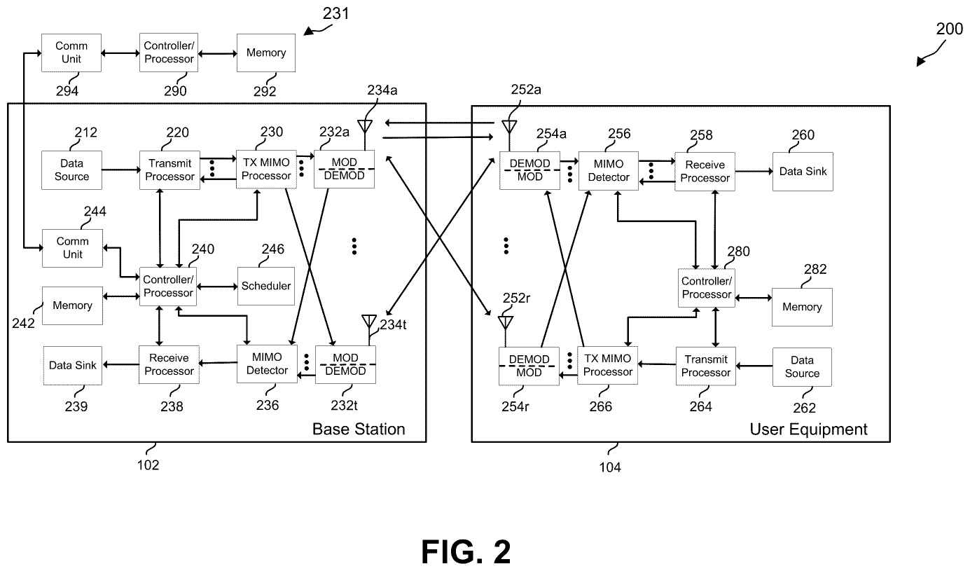

FIG. 2 shows a block diagram of a design of a base station 102 and a UE 104 that enable transmission and processing of signals exchanged between the UE and the base station, in accordance with some aspects of the present disclosure. Design 200 includes components of a base station 102 and a UE 104, which may be one of the base stations 102 and one of the UEs 104 in FIG. 1. Base station 102 may be equipped with T antennas 234a through 234t, and UE 104 may be equipped with R antennas 252a through 252r, where in general T≥1 and R≥1.

At base station 102, a transmit processor 220 may receive data from a data source 212 for one or more UEs, select one or more modulation and coding schemes (MCS) for each UE based at least in part on channel quality indicators (CQIs) received from the UE, process (e.g., encode and modulate) the data for each UE based at least in part on the MCS(s) selected for the UE, and provide data symbols for all UEs. Transmit processor 220 may also process system information (e.g., for semi-static resource partitioning information (SRPI) and/or the like) and control information (e.g., CQI requests, grants, upper layer signaling, and/or the like) and provide overhead symbols and control symbols. Transmit processor 220 may also generate reference symbols for reference signals (e.g., the cell-specific reference signal (CRS)) and synchronization signals (e.g., the primary synchronization signal (PSS) and secondary synchronization signal (SSS)). A transmit (TX) multiple-input multiple-output 1 (MIMO) processor 230 may perform spatial processing (e.g., precoding) on the data symbols, the control symbols, the overhead symbols, and/or the reference symbols, if applicable, and may provide T output symbol streams to T modulators (MODs) 232a through 232t. The modulators 232a through 232t are shown as a combined modulator-demodulator (MOD-DEMOD). In some cases, the modulators and demodulators can be separate components. Each modulator of the modulators 232a to 232t may process a respective output symbol stream, e.g., for an orthogonal frequency-division multiplexing (OFDM) scheme and/or the like, to obtain an output sample stream. Each modulator of the modulators 232a to 232t may further process (e.g., convert to analog, amplify, filter, and upconvert) the output sample stream to obtain a downlink signal. T downlink signals may be transmitted from modulators 232a to 232t via T antennas 234a through 234t, respectively. According to certain aspects described in more detail below, the synchronization signals can be generated with location encoding to convey additional information.

At UE 104, antennas 252a through 252r may receive the downlink signals from base station 102 and/or other base stations and may provide received signals to demodulators (DEMODs) 254a through 254r, respectively. The demodulators 254a through 254r are shown as a combined modulator-demodulator (MOD-DEMOD). In some cases, the modulators and demodulators can be separate components. Each demodulator of the demodulators 254a through 254r may condition (e.g., filter, amplify, downconvert, and digitize) a received signal to obtain input samples. Each demodulator of the demodulators 254a through 254r may further process the input samples (e.g., for OFDM and/or the like) to obtain received symbols. A MIMO detector 256 may obtain received symbols from all R demodulators 254a through 254r, perform MIMO detection on the received symbols if applicable, and provide detected symbols. A receive processor 258 may process (e.g., demodulate and decode) the detected symbols, provide decoded data for UE 104 to a data sink 260, and provide decoded control information and system information to a controller/processor 280. A channel processor may determine reference signal received power (RSRP), received signal strength indicator (RSSI), reference signal received quality (RSRQ), channel quality indicator (CQI), and/or the like.

On the uplink, at UE 104, a transmit processor 264 may receive and process data from a data source 262 and control information (e.g., for reports comprising RSRP, RSSI, RSRQ, CQI, and/or the like) from controller/processor 280. Transmit processor 264 may also generate reference symbols for one or more reference signals (e.g., based at least in part on a beta value or a set of beta values associated with the one or more reference signals). The symbols from transmit processor 264 may be precoded by a TX-MIMO processor 266 if application, further processed by modulators 254a through 254r (e.g., for DFT-s-OFDM, CP-OFDM, and/or the like), and transmitted to base station 102. At base station 102, the uplink signals from UE 104 and other UEs may be received by antennas 234a through 234t, processed by demodulators 232a through 232t, detected by a MIMO detector 236 if applicable, and further processed by a receive processor 238 to obtain decoded data and control information sent by UE 104. Receive processor 238 may provide the decoded data to a data sink 239 and the decoded control information to controller (processor) 240. Base station 102 may include communication unit 244 and communicate to a network controller 231 via communication unit 244. Network controller 231 may include communication unit 294, controller/processor 290, and memory 292.

In some aspects, one or more components of UE 104 may be included in a housing. Controller 240 of base station 102, controller/processor 280 of UE 104, and/or any other component(s) of FIG. 2 may perform one or more techniques associated with implicit UCI beta value determination for NR.

Memories 242 and 282 may store data and program codes for the base station 102 and the UE 104, respectively. A scheduler 246 may schedule UEs for data transmission on the downlink, uplink, and/or sidelink.

In some aspects, deployment of communication systems, such as 5G new radio (NR) systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUS)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU also can be implemented as virtual units, i.e., a virtual central unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

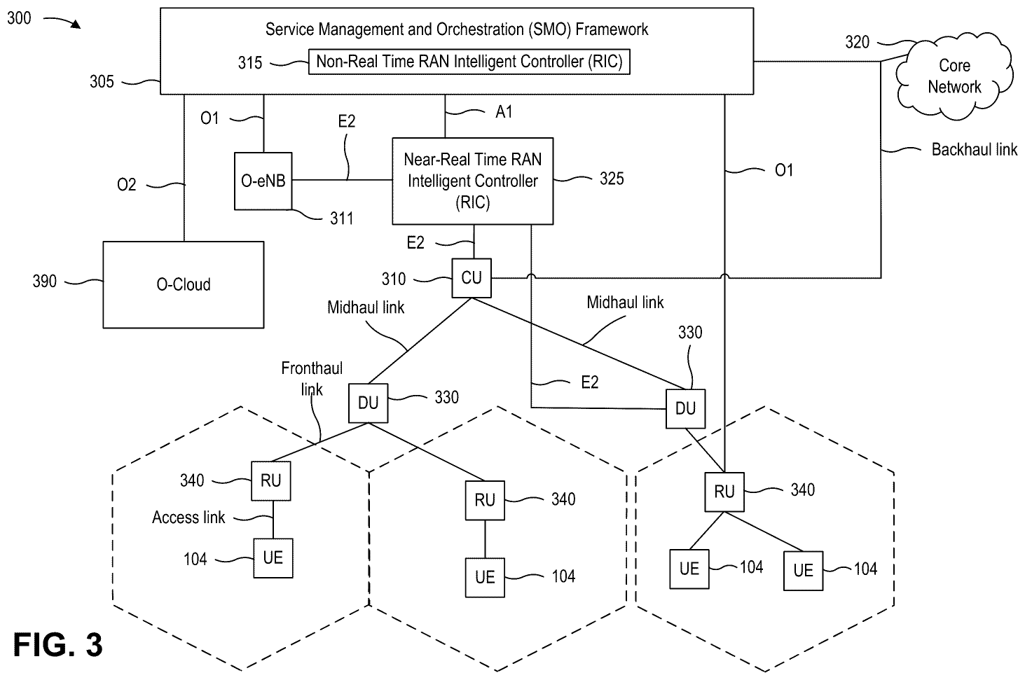

FIG. 3 shows a diagram illustrating an example disaggregated base station 300 architecture. The disaggregated base station 300 architecture may include one or more central units (CUs) 310 that can communicate directly with a core network 320 via a backhaul link, or indirectly with the core network 320 through one or more disaggregated base station units (such as a Near-Real Time (Near-RT) RAN Intelligent Controller (RIC) 325 via an E2 link, or a Non-Real Time (Non-RT) RIC 315 associated with a Service Management and Orchestration (SMO) Framework 305, or both). A CU 310 may communicate with one or more distributed units (DUs) 330 via respective midhaul links, such as an F1 interface. The DUs 330 may communicate with one or more radio units (RUS) 340 via respective fronthaul links. The RUs 340 may communicate with respective UEs 104 via one or more radio frequency (RF) access links. In some implementations, the UE 104 may be simultaneously served by multiple RUs 340.

Each of the units, e.g., the CUS 310, the DUs 330, the RUs 340, as well as the Near-RT RICs 325, the Non-RT RICs 315 and the SMO Framework 305, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 310 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 310. The CU 310 may be configured to handle user plane functionality (i.e., Central Unit-User Plane (CU-UP)), control plane functionality (i.e., Central Unit-Control Plane (CU-CP)), or a combination thereof. In some implementations, the CU 310 can be logically split into one or more CU-UP units and one or more CU-CP units. The CU-UP unit can communicate bidirectionally with the CU-CP unit via an interface, such as the E1 interface when implemented in an O-RAN configuration. The CU 310 can be implemented to communicate with the DU 330, as necessary, for network control and signaling.

The DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3rd Generation Partnership Project (3GPP). In some aspects, the DU 330 may further host one or more low PHY layers. Each layer (or module) can be implemented with an interface configured to communicate signals with other layers (and modules) hosted by the DU 330, or with the control functions hosted by the CU 310.

Lower-layer functionality can be implemented by one or more RUs 340. In some deployments, an RU 340, controlled by a DU 330, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 340 can be implemented to handle over the air (OTA) communication with one or more UEs 104. In some implementations, real-time and non-real-time aspects of control and user plane communication with the RU(s) 340 can be controlled by the corresponding DU 330. In some scenarios, this configuration can enable the DU(s) 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements which may be managed via an operations and maintenance interface (such as an O1 interface). For virtualized network elements, the SMO Framework 305 may be configured to interact with a cloud computing platform (such as an open cloud (O-Cloud) 390) to perform network element life cycle management (such as to instantiate virtualized network elements) via a cloud computing platform interface (such as an O2 interface). Such virtualized network elements can include, but are not limited to, CUs 310, DUs 330, RUs 340 and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with one or more RUs 340 via an O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via O1) or via creation of RAN management policies (such as A1 policies).

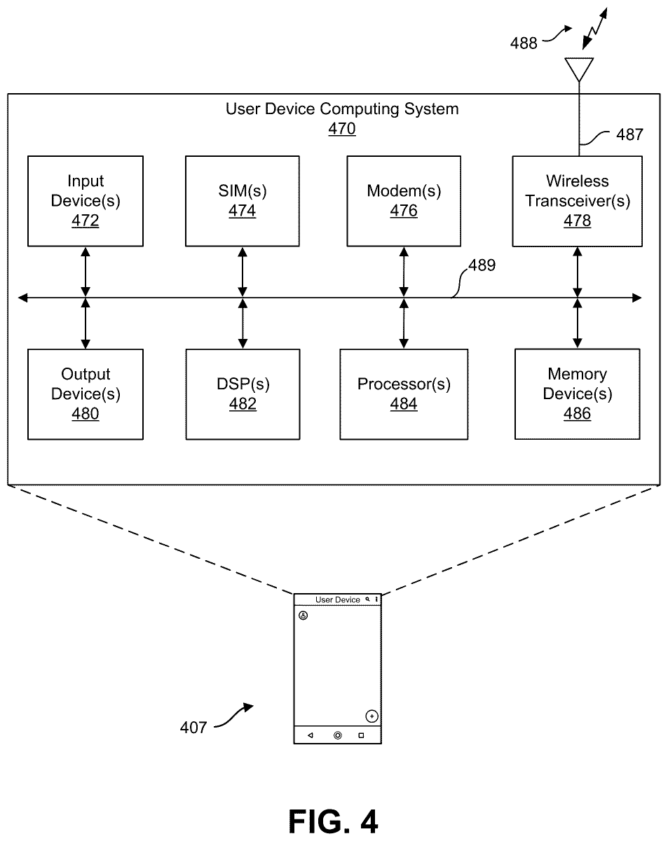

FIG. 4 illustrates an example of a computing system 470 of a wireless device 407. The wireless device 407 can include a client device such as a UE (e.g., UE 104, UE 152, UE 190) or other type of device (e.g., a station (STA) configured to communication using a Wi-Fi interface) that can be used by an end-user. For example, the wireless device 407 can include a mobile phone, router, tablet computer, laptop computer, tracking device, wearable device (e.g., a smart watch, glasses, an extended reality (XR) device such as a virtual reality (VR), augmented reality (AR) or mixed reality (MR) device, etc.), Internet of Things (IoT) device, access point, and/or another device that is configured to communicate over a wireless communications network. The computing system 470 includes software and hardware components that can be electrically or communicatively coupled via a bus 489 (or may otherwise be in communication, as appropriate). For example, the computing system 470 includes one or more processors 484. The one or more processors 484 can include one or more CPUs, ASICs, FPGAs, APs, GPUs, VPUs, NSPs, microcontrollers, dedicated hardware, any combination thereof, and/or other processing device or system. The bus 489 can be used by the one or more processors 484 to communicate between cores and/or with the one or more memory devices 486.

The computing system 470 may also include one or more memory devices 486, one or more digital signal processors (DSPs) 482, one or more subscriber identity modules (SIMs) 474, one or more modems 476, one or more wireless transceivers 478, one or more antennas 487, one or more input devices 472 (e.g., a camera, a mouse, a keyboard, a touch sensitive screen, a touch pad, a keypad, a microphone, and/or the like), and one or more output devices 480 (e.g., a display, a speaker, a printer, and/or the like).

In some aspects, computing system 470 can include one or more radio frequency (RF) interfaces configured to transmit and/or receive RF signals. In some examples, an RF interface can include components such as modem(s) 476, wireless transceiver(s) 478, and/or antennas 487. The one or more wireless transceivers 478 can transmit and receive wireless signals (e.g., signal 488) via antenna 487 from one or more other devices, such as other wireless devices, network devices (e.g., base stations such as eNBs and/or gNBs, Wi-Fi access points (APs) such as routers, range extenders or the like, etc.), cloud networks, and/or the like. In some examples, the computing system 470 can include multiple antennas or an antenna array that can facilitate simultaneous transmit and receive functionality. Antenna 487 can be an omnidirectional antenna such that radio frequency (RF) signals can be received from and transmitted in all directions. The wireless signal 488 may be transmitted via a wireless network. The wireless network may be any wireless network, such as a cellular or telecommunications network (e.g., 3G, 4G, 5G, etc.), wireless local area network (e.g., a Wi-Fi network), a Bluetooth™ network, and/or other network.

In some examples, the wireless signal 488 may be transmitted directly to other wireless devices using sidelink communications (e.g., using a PC5 interface, using a DSRC interface, etc.). Wireless transceivers 478 can be configured to transmit RF signals for performing sidelink communications via antenna 487 in accordance with one or more transmit power parameters that can be associated with one or more regulation modes. Wireless transceivers 478 can also be configured to receive sidelink communication signals having different signal parameters from other wireless devices.

In some examples, the one or more wireless transceivers 478 may include an RF front end including one or more components, such as an amplifier, a mixer (also referred to as a signal multiplier) for signal down conversion, a frequency synthesizer (also referred to as an oscillator) that provides signals to the mixer, a baseband filter, an analog-to-digital converter (ADC), one or more power amplifiers, among other components. The RF front-end can generally handle selection and conversion of the wireless signals 488 into a baseband or intermediate frequency and can convert the RF signals to the digital domain.

In some cases, the computing system 470 can include a coding-decoding device (or CODEC) configured to encode and/or decode data transmitted and/or received using the one or more wireless transceivers 478. In some cases, the computing system 470 can include an encryption-decryption device or component configured to encrypt and/or decrypt data (e.g., according to the AES and/or DES standard) transmitted and/or received by the one or more wireless transceivers 478.

The one or more SIMs 474 can each securely store an international mobile subscriber identity (IMSI) number and related key assigned to the user of the wireless device 407. The IMSI and key can be used to identify and authenticate the subscriber when accessing a network provided by a network service provider or operator associated with the one or more SIMs 474. The one or more modems 476 can modulate one or more signals to encode information for transmission using the one or more wireless transceivers 478. The one or more modems 476 can also demodulate signals received by the one or more wireless transceivers 478 in order to decode the transmitted information. In some examples, the one or more modems 476 can include a Wi-Fi modem, a 4G (or LTE) modem, a 5G (or NR) modem, and/or other types of modems. The one or more modems 476 and the one or more wireless transceivers 478 can be used for communicating data for the one or more SIMs 474.

The computing system 470 can also include (and/or be in communication with) one or more non-transitory machine-readable storage media or storage devices (e.g., one or more memory devices 486), which can include, without limitation, local and/or network accessible storage, a disk drive, a drive array, an optical storage device, a solid-state storage device such as a RAM and/or a ROM, which can be programmable, flash-updateable and/or the like. Such storage devices may be configured to implement any appropriate data storage, including without limitation, various file systems, database structures, and/or the like.

In various embodiments, functions may be stored as one or more computer-program products (e.g., instructions or code) in memory device(s) 486 and executed by the one or more processor(s) 484 and/or the one or more DSPs 482. The computing system 470 can also include software elements (e.g., located within the one or more memory devices 486), including, for example, an operating system, device drivers, executable libraries, and/or other code, such as one or more application programs, which may comprise computer programs implementing the functions provided by various embodiments, and/or may be designed to implement methods and/or configure systems, as described herein.

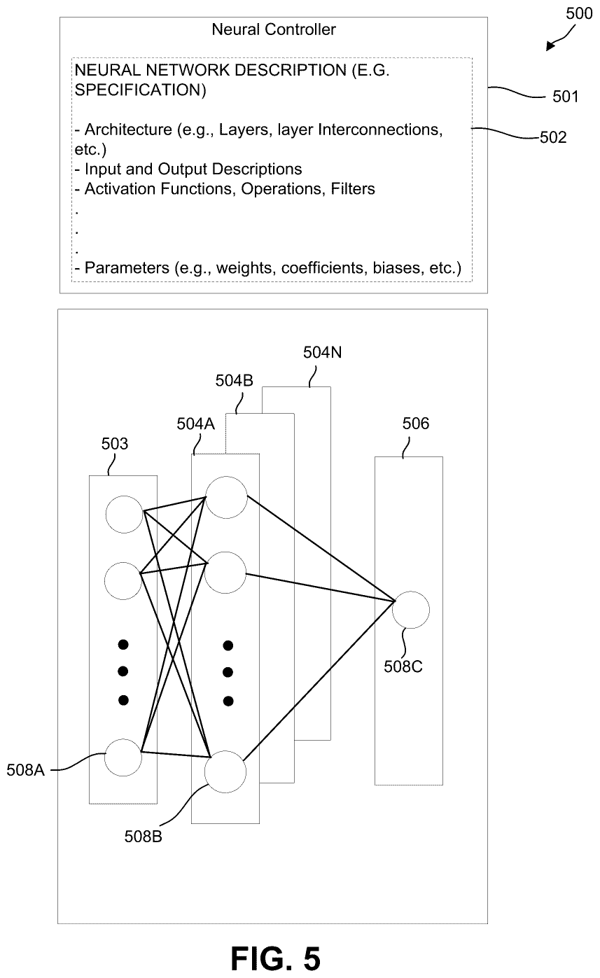

FIG. 5 illustrates an example neural architecture of a neural network 500 that can be trained to perform predictive beam management for secondary cell group (SCG) setup, in accordance with some aspects of the present disclosure. The example neural architecture of the neural network 500 may be defined by an example neural network description 502 in neural controller 501. The neural network 500 is an example of a machine learning model that can be deployed and implemented at the base station 102, the central unit (CU) 310, the distributed unit (DU) 330, the radio unit (RU) 340, and/or the UE 104. The neural network 500 can be a feedforward neural network or any other known or to-be-developed neural network or machine learning model.

The neural network description 502 can include a full specification of the neural network 500, including the neural architecture shown in FIG. 5. For example, the neural network description 502 can include a description or specification of architecture of the neural network 500 (e.g., the layers, layer interconnections, number of nodes in each layer, etc.); an input and output description which indicates how the input and output are formed or processed; an indication of the activation functions in the neural network, the operations or filters in the neural network, etc.; neural network parameters such as weights, biases, etc.; and so forth.

The neural network 500 can reflect the neural architecture defined in the neural network description 502. The neural network 500 can include any suitable neural or deep learning type of network. In some cases, the neural network 500 can include a feedforward neural network. In other cases, the neural network 500 can include a recurrent neural network, which can have loops that allow information to be carried across nodes while reading in input. The neural network 500 can include any other suitable neural network or machine learning model. One example includes a convolutional neural network (CNN), which includes an input layer and an output layer, with multiple hidden layers between the input and out layers. The hidden layers of a CNN include a series of hidden layers as described below, such as convolutional, nonlinear, pooling (for downsampling), and fully connected layers. In other examples, the neural network 500 can represent any other neural or deep learning network, such as an autoencoder, a deep belief nets (DBNs), a recurrent neural network (RNN), etc.

In the non-limiting example of FIG. 5, the neural network 500 includes an input layer 503, which can receive one or more sets of input data. The input data can be any type of data such as one or more channel measurements associated with a signal or transmission beam received from a first network entity (e.g., corresponding to a first serving cell). For example, the input data may include reference signal received power (RSRP), received signal strength indicator (RSSI), reference signal quality (RSRQ), channel quality indicator (CQI), power delay profile (PDP), angle of arrival (AoA), angle of departure (AoD), angular spread, explicit time/frequency domain channel characteristics, Eigen vector(s) associated with the channel in the frequency domain, any combination thereof, and/or any other channel measurements or channel characteristics.

The neural network 500 can include hidden layers 504A through 504N (collectively “504” hereinafter). The hidden layers 504 can include n number of hidden layers, where n is an integer greater than or equal to one. The n number of hidden layers can include as many layers as needed for a desired processing outcome and/or rendering intent. In one illustrative example, any one of the hidden layers 504 can include data representing one or more of the data provided at the input layer 503 such as one or more parameters associated with a communication channel or a transmission beam.

The neural network 500 further includes an output layer 506 that provides an output resulting from the processing performed by hidden layers 504. The output layer 506 can provide output data based on the input data. In one example, in the context related to performing predictive beam management for secondary cell group (SCG) setup, the output can include one or more parameters associated with channels or beams corresponding to a different network entity (e.g., corresponding to a secondary serving cell). For example, the output can include an angle of arrival (AoA), an angle of departure (AoD), a synchronization signal block (SSB) index. a channel state information reference signal (CSI-RS) resource identifier, any combination thereof, and/or any other channel parameter that is associated with a different network entity (e.g., a secondary serving cell).

In the example of FIG. 5, the neural network 500 is a multi-layer neural network of interconnected nodes. Each node can represent a piece of information. Information associated with the nodes is shared among the different layers and each layer retains information as information is processed. Information can be exchanged between the nodes through node-to-node interconnections between the various layers. The nodes of the input layer 503 can activate a set of nodes in the first hidden layer 504A. For example, as shown, each input node of the input layer 503 is connected to each node of the first hidden layer 504A. The nodes of the hidden layer 504A can transform the information of each input node by applying activation functions to the information. The information derived from the transformation can then be passed to and can activate the nodes of the next hidden layer (e.g., 504B), which can perform their own designated functions. Example functions include convolutional, up-sampling, data transformation, pooling, and/or any other suitable functions. The output of hidden layer (e.g., 504B) can then activate nodes of the next hidden layer (e.g., 504N), and so on. The output of last hidden layer can activate one or more nodes of the output layer 506, at which point an output can be provided. In some cases, while nodes (e.g., nodes 508A, 508B, 508C) in the neural network 500 are shown as having multiple output lines, a node can have a single output and all lines shown as being output from a node can represent the same output value.

In some cases, each node or interconnection between nodes can have a weight that is a set of parameters derived from training the neural network 500. For example, an interconnection between nodes can represent a piece of information learned about the interconnected nodes. The interconnection can have a numeric weight that can be tuned (e.g., based on a training dataset), allowing the neural network 500 to be adaptive to inputs and able to learn as more data is processed.

The neural network 500 can be pre-trained to process the features from the data in the input layer 503 using different hidden layers 504 in order to provide the output through the output layer 506. For example, in some cases, the neural network 500 can adjust weights of nodes using a training process called backpropagation. Backpropagation can include a forward pass, a loss function, a backward pass, and a weight update. The forward pass, loss function, backward pass, and parameter update can be performed for one training iteration. The process can be repeated for a certain number of iterations for each set of training data until the weights of the layers are accurately tuned (e.g., meet a configurable threshold determined based on experiments and/or empirical studies).

Once trained, the neural network 500 can receive as input one or more channel measurements associated with a communication channel between the UE 104 and a network entity (e.g., base station 102, RU 340, etc.). Such measurements can include, but are not limited to, measurements associated with channels or transmission beams transmitted by a network entity (e.g., RSRP, RSSI, RSRQ, CQI, PDP, AoA, AoD, angular spread, explicit time/frequency domain channel characteristics, Eigen vector(s) associated with the channel in the frequency domain, etc.).

Once trained, the neural network 500 can provide a linkage between channels or beams associated with a first network entity and channels or beams associated with a second network entity. For example, the trained neural network 500 can determine one or more parameters associated with a second network entity based on the measurements corresponding to the first network entity. In some cases, the output of the trained neural network 500 can include an angle of arrival (AoA), an angle of departure (AoD), a synchronization signal block (SSB) index and/or a channel state information reference signal (CSI-RS) resource identifier. In some aspects, a UE may use the output of trained neural network 500 to perform secondary cell group (SCG) setup.

As will be described below, the trained neural network 500 can be deployed at the UE 104, at a network entity (e.g., base station 102, RU 340, DU 330, CU 310, etc.), or at the UE 104 and a network entity. In one example, when the machine learning model is deployed at the base station 102, the base station 102 may receive the one or more input parameters (e.g., measurements, channel state information, etc.) from the UE 104 and determine the parameters associated with a secondary network entity as output of the trained neural network.

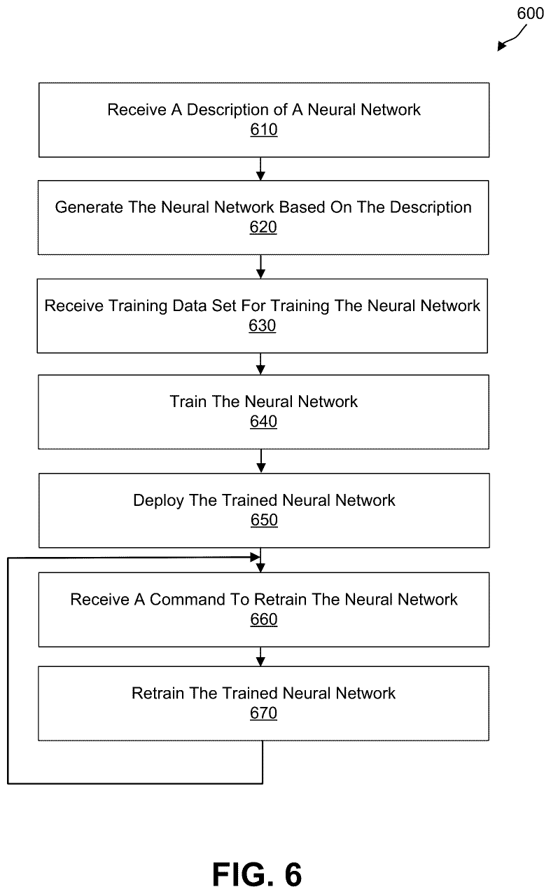

FIG. 6 is a flow chart of a process 600 of training a machine learning algorithm, such as neural network 500, for determining channel parameters associated with a secondary network entity based on channel measurements associated with a first network entity, in accordance with some aspects of the present disclosure. Operation of FIG. 6 will be described in relation to FIG. 5. Neural network 500 may be implemented at the base station 102, the central unit (CU) 310, the distributed unit (DU) 330, the radio unit (RU) 340, and/or the UE 104.

At operation 610, the neural controller 501 receives a description of the structure of the neural network 500 (e.g., from base station 102) including, but not limited to, the architecture of the neural network 500 and definition of layers, layer interconnections, input and output descriptions, activation functions, operations, filters, parameters such as weights, coefficients, biases, etc. In some examples, the description can be received from a device based on a user input received by the device (e.g., input via an input device, such as a keyboard, mouse, touchscreen interface, and/or other type of input device). In some examples, operation 610 is optional and may not be performed. For example, the neural network 500 can be UE specific (e.g., executed by the UE) and thus the description and specific configurations of the neural network 500 may be provided by the UE 104. At operation 620, the neural network 500 is generated based on the description received at operation 610. Using the description, the neural controller 501 generates appropriate input, intermediate, and output layers with defined interconnections between the layers and/or any weights or other parameters/coefficients assigned thereto. The weights and/or other parameters/coefficients can be set to initialized values, which will be modified during training, as described below. In some examples, operation 620 is optional and may not be performed (e.g., when the neural network 500 is UE specific).

At operation 630, once the neural network 500 is defined, a training data set is provided to the input layer 503 of the neural network 500. In some examples, there may not be an explicitly dedicated training data set for the purpose of training the neural network 500 or the training data set may not necessarily be a predetermined data set. In some examples, the real-time data can be used for live training of the neural network 500, for example, using an online-learning approach. In some aspects, the training data set may include a portion of the training data (e.g., distributed training). In some cases that implement distributed training, the training data may be independent and identically distributed (IID). In some cases, that implement federated training and/or hierarchical federated training, the training data may be private or local to the UE. In some examples, the data among UEs may not be IID.

At operation 640, the neural network 500 is trained using the training data set, a portion of the training data set, or a localized private data set on a client device (e.g., a UE). As noted above, training of the neural network can be performed using centralized learning, distributed learning, federated learning, hierarchical federated learning, and/or any other suitable learning technique. In one example, the training of the neural network 500 is an iterative process repeated multiple times. In some cases, each iteration of training can include a validation using a test data set. The test data set may include a set of one or more parameters similar to those used as part of the training dataset and associated output preference levels for one or more parameters. During each iteration, the output at the output layer 506 can be compared to the desired output in the training data set and a delta between the output at the output layer 506 at that iteration and the desired output defined in the training data set can be determined. The weights and other parameters or coefficients of the various layers can be adjusted based on the delta. The iterative process may continue until the delta for any given set of input parameters is less than a threshold (e.g., optimizing or minimizing a loss function). The threshold may be a configurable parameter determined based on experiments and/or empirical studies.

At operation 650 and once the neural network 500 is trained, the trained neural network 500 can be deployed at the base station 102, the central unit (CU) 310, the distributed unit (DU) 330, the radio unit (RU) 340, the UE 104, and/or any other apparatus. The trained neural network, as will be described below, can then be used to determine a linkage or relationship among network entities. For example, the trained neural network can be used to determine a linkage between a first number of synchronization signal blocks (SSBs) or channel state information reference signal (CSI-RS) resource identifiers associated with a first network entity (e.g., a first serving cell in a master cell group) and a second number of SSBs or CSI-RS resource identifiers associated with a second network entity (e.g., a second serving cell in a secondary cell group). As the measurements change, the receiving device (e.g., base station 102, UE 104, or any other network entity on which the trained neural network 500 is deployed) can re-train the neural network 500 to determine updated linkages among network entities.

At operation 660, a triggering condition for retraining the neural network 500 can be detected. In some cases, the command may be received after the trained neural network 500 is deployed. At operation 670, the neural network 500 is retrained using the parameters or data received as part of the command at operation 660.

Retraining the neural network 500 may include adjusting weights, coefficients, biases, and/or parameters at different nodes of the different layers of the neural network 500. The operation 660 and 670 (the retraining of the neural network 500) may be continuously repeated, thus resulting in increased accuracy of the neural network 500 over time. In some aspects, retraining of the neural network 500 can be implemented using centralized learning, distributed learning, federated learning, hierarchical federated learning, and/or any other suitable learning technique.

As noted above, systems and techniques are described herein for performing predictive beam management for secondary cell group (SCG) setup. In some cases, the systems and techniques can be implemented by a user equipment (UE). For example, the systems and techniques can be implemented by UE 104. In some aspects, the systems and techniques can be implemented by one or more network entities. For example, the systems and techniques can be implemented by a base station 102, a centralized unit (CU) 310, a distributed unit (DU) 330, a radio unit (RU) 340, and/or a core network 320. The systems and techniques can determine a linkage or association between channel measurements associated with a first network entity and parameters associated with a second network entity. For example, the systems and techniques can use channel measurements associated with the first network entity to determine linkages between a first number of synchronization signal blocks (SSBs) or channel state information reference signal (CSI-RS) resource identifiers associated with a first network entity (e.g., a first serving cell in a master cell group) and a second number of SSBs or CSI-RS resource identifiers associated with a second network entity (e.g., a second serving cell in a secondary cell group).

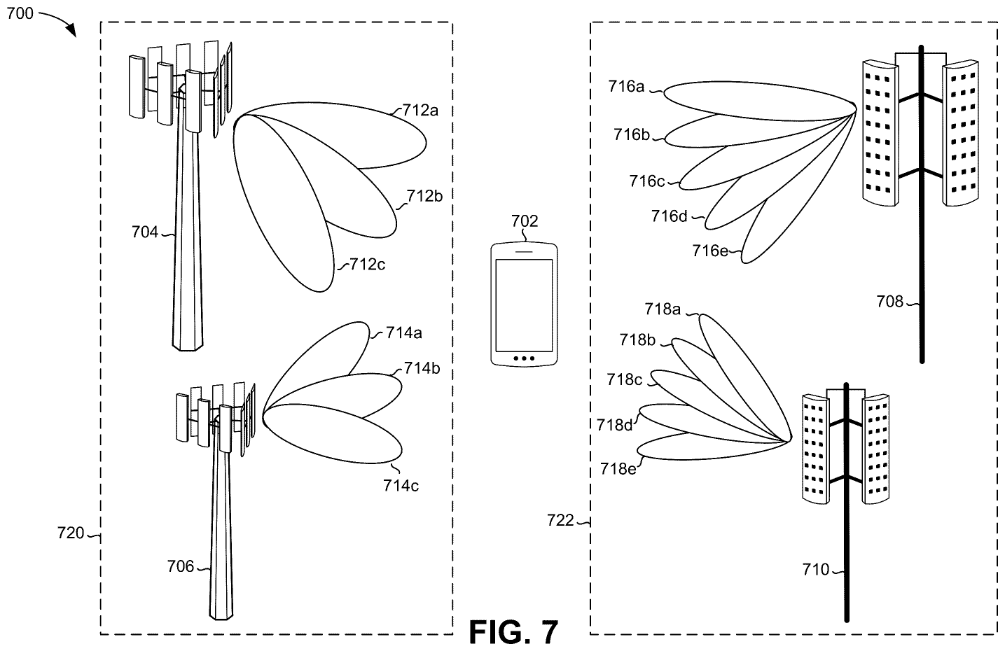

FIG. 7 illustrates an example of a wireless communication system 700 for implementing predictive beam management for secondary cell group (SCG) setup. In some aspects, the system 700 can include user equipment (UE) 702. As noted above, a UE may include and/or be referred to as an access terminal, a user device, a user terminal, a client device, a wireless device, a subscriber device, a subscriber terminal, a subscriber station, a mobile device, a mobile terminal, a mobile station, or variations thereof. In some aspects, a UE can include a mobile telephone or so-called “smart phone”, a tablet computer, a wearable device, an extended reality device (e.g., a virtual reality (VR) device, an augmented reality (AR) device, or a mixed reality (MR) device), a personal computer, a laptop computer, an internet of things (IoT) device, a television, a vehicle (or a computing device of a vehicle), or any other device having a radio frequency (RF) interface.

In some examples, the system 700 can include one or more network entities such as network entity 704, network entity 706, network entity 708, and network entity 710. In some aspects, network entity 704 and network entity 706 may be part of master cell group (MCG) 720. For instance, network entity 704 may correspond to a primary serving cell (PCell) in MCG 720 and network entity 706 may correspond to a secondary serving cell (SCell) in MCG 720. In some cases, network entity 708 and network entity 710 may be part of secondary cell group (SCG) 722. For example, network entity 708 may correspond to a primary secondary serving cell (PSCell) in SCG 722 and network entity 710 may correspond to an SCell in SCG 722.

In some aspects, one or more of the network entities may transmit one or more radio frequency (RF) signals. In some cases, the RF signals may be transmitted in one or more directions using transmission beams. For example, network entity 704 can transmit beam 712a, beam 712b, and beam 712c (collectively referred to as “beams 712”). In some aspects, beams 712 may be transmitted using a frequency range (FR) such as FRI (e.g., from 450 to 6000 MHz). In another example, network entity 706 can transmit beam 714a, beam 714b, and beam 714c (collectively referred to as “beams 714”). In some cases, beams 714 may be transmitted using FR3 (e.g., above 52600 MHZ).

In some examples, network entity 708 can transmit beam 716a, beam 716b, beam 716c, beam 716d, and beam 716e (collectively referred to as “beams 716”). In some cases, beams 716 may be transmitted using the same or a different FR than beams 712 and/or beams 714. For example, beams 716 may be transmitted using FR2 (e.g., from 24250 to 52600 MHZ). In some instances, network entity 710 can transmit beam 718a, beam 718b, beam 718c, beam 718d, and beam 718e (collectively referred to as “beams 718”). In some configurations, beams 718 may also be transmitted using FR2.

In some cases, UE 702 can perform channel measurements on one or more beams transmitted by a network entity. For example, UE 702 can perform channel measurement on beams 712, beams 714, beams 716, and/or beams 718. In some examples, the channel measurements can include reference signal received power (RSRP), received signal strength indicator (RSSI), reference signal quality (RSRQ), channel quality indicator (CQI), power delay profile (PDP), angle of arrival (AoA), angle of departure (AoD), angular spread, explicit time/frequency domain channel characteristics, Eigen vector(s) associated with the channel in the frequency domain, any combination thereof, and/or any other channel measurements or channel characteristics.

In some examples, UE 702 may use channel measurements associated with a first network entity to determine one or more parameters associated with a second network entity. For example, UE 702 may obtain channel measurement associated with beams 712 to identify one or more parameters associated with beams 716. In some cases, UE 702 may be configured with linkages that may be used to associate measurements obtained from a first network entity with parameters associated with a second network entity. In some aspects, the linkages may be explicitly configured in UE 702 (e.g., received from a network entity). In some examples, the linkages may be determined by UE 702 using a machine learning model (e.g., neural network 500). In some aspects, UE 702 may be configured to use one or more machine learning models by a network entity.

For example, UE 702 may obtain channel measurements corresponding to beams 712 that are transmitted using a first frequency range (e.g., FR1). In some cases, UE 702 may use linkages to associate the channel measurements corresponding to beams 712 with one or more parameters corresponding to beams 716. In some aspects, the one or more parameters corresponding to beams 716 may include one or more synchronization signal blocks (SSB) indices corresponding to beams 716. In some instances, the one or more parameters corresponding to beams 716 may include channel state information reference signal (CSI-RS) resource identifiers corresponding to beams 716. In some examples, the one or more parameters corresponding to beams 716 may include an angle of arrival (AoA), an angle of departure (AoD), a power delay profile (PDP), angular spread, explicit time/frequency domain channel characteristics, Eigen vector(s) associated with the channel in the frequency domain, and/or any other parameter.

In some cases, beams 716 may be transmitted using a different FR (e.g., FR2) than beams 712. In some examples, UE 702 may use the parameters corresponding to beams 716 (e.g., determined based on linkages to beams 712) to identify one or more preferred beams (e.g., beam 716a, beam 716b, beam 716c, beam 716d, and/or beam 716e) to communicate with network entity 708. In some aspects, UE 702 may obtain further measurements associated with the one or more preferred beams to identify a single preferred beam for communicating with network entity 708. In some examples, UE 702 may use the single preferred beam to initiate random access channel (RACH) procedures with network entity 708 (e.g., for setting up communication with SCG 722). For example, UE 702 may use the single preferred beam to transmit a random access request message (e.g., Message 1 or Message A).

In some aspects, UE 702 may transmit one or more measurements associated with beams 712 to network entity 704. For example, UE 702 may transmit a feedback message that includes measurements such as RSRP, RSSI, RSRQ, CQI, PDP, and/or explicit channel measurements such as angle of arrival (AoA), angle of departure (AoD), angular spread, time/frequency domain channel characteristics, Eigen vector(s) associated with the channel in the frequency domain, etc. In some examples, network entity 704 may be configured to use linkages that can map the measurements associated with beams 712 to parameters associated with beams 716. For example, network entity 704 may use a machine learning model to process one or more of the measurements associated with beams 712 to determine one or more SSB indices, CSI-RS resource identifiers, and/or explicit channel parameters (e.g., AoA, AoD, etc.) associated with beams 716.

In some examples, UE 702 may transmit one or more parameters associated with network entity 708 to network entity 704. For example, UE 702 may transmit one or more parameters (e.g., AoA, AoD, angular spreads, etc.) corresponding to beams 716 that are determined based on channel measurements of beams 712. In some aspects, network entity 704 may use the one or more parameters to identify one or more SSB indices and/or CSI-RS resource identifiers corresponding to network entity 708. In some cases, network entity 704 may communicate with network entity 708 to identify the SSB indices and/or the CSI-RS resource identifiers.

In some cases, network entity 704 may transmit an indication to UE 702 that can identify one or more preferred beams (e.g., beam 716a, beam 716b, beam 716c, beam 716d, and/or beam 716e) that UE 702 can use to communicate with network entity 708. For example, the indication may include one or more SSB indices and/or the CSI-RS resource identifiers associated with network entity 708. In some examples, UE 702 may obtain measurements associated with the one or more preferred beams in order to identify a single preferred beam for communicating with network entity 708. In some examples, UE 702 may use the single preferred beam to initiate random access channel (RACH) procedures with network entity 708 (e.g., for setting up communication with SCG 722).

In some aspects, the indication from network entity 704 to UE 702 may identify a single preferred beam for UE 702 to communicate with network entity 708. In some examples, the indication may correspond to a transmission configuration indicator (TCI). For instance, the TCI may be associated with a single SSB index and/or CSI-RS resource identifier that may be defined in network entity 708 (e.g., the PSCell) as a virtual default downlink and/or uplink TCI-state. In some cases, the SSB index or the CSI-RS resource identifier indicated in the TCI can be used by UE 702 for physical downlink shared channel (PDSCH) or physical uplink shared channel (PUSCH) communications with network entity 708. In some aspects, UE 702 may use the single preferred beam to communicate with network entity 708 using a PUSCH transmission (e.g., UE 702 may communicate without performing RACH procedure).

In some examples, UE 702 may use one or more linkages to associate measurements corresponding to a first network entity with multiple network entities. For instance, UE 702 may be configured with a linkage (e.g., explicitly or implemented via a machine learning algorithm) that can associate measurements corresponding to network entity 704 with network entity 708 and network entity 710. In some examples, a single linkage scheme can be used to associate measurements obtained from beams 712 with parameters for beams 716 and beams 718. For example, a single linkage may be used to identify an SSB index and/or a CSI-RS resource identifier that respectively correspond to network entity 708 and network entity 710 based on measurements corresponding to network entity 704.

In some cases, UE 702 may implement separate linkage schemes (e.g., separate machine learning models or separate machine learning components) that can be used to independently associate measurements obtained from beams 712 with beams 716 and beams 718, respectively. In some aspects, the linkage schemes can be associated with a serving cell identifier (ID). In some examples, UE 702 may transmit the serving cell ID to a network entity (e.g., network entity 704) together with a feedback message that includes channel measurements (e.g., measurements associated with network entity 704) and/or parameters associated with a different network entity (e.g., determined based on linkage and channel measurements).

In some examples, UE 702 can obtain channel measurements from multiple network entities to determine parameters for another network entity. For instance, UE 702 can obtain channel measurements associated with network entity 704 (e.g., from beams 712 transmitted using FR1) and channel measurements associated with network entity 706 (e.g., from beams 714 transmitted using FR3) to determine parameters associated with network entity 708 (e.g., corresponding to beams 716 transmitted using FR2). In some cases, UE 702 may use a single linkage scheme to process the channel measurements corresponding to network entity 704 and network entity 706. For instance, UE 702 may be configured with an ML model that receives input including RSRP measured from SSBs associated with network entity 704 (e.g., using FR1) and RSRP measured from SSBs associated with network entity 706 (e.g., using FR3). In some aspects, the ML model may output one or more preferred SSB indices and/or CSI-RS resource identifiers for UE 702 to communicate with network entity 708.

In some aspects, UE 702 may implement different linkage schemes (e.g., different ML models or different ML components) to process channel measurements corresponding to network entity 704 and channel measurements corresponding to network entity 706. For example, UE 702 may be configured with a first linkage scheme that can be used to associate SSB indices and/or CSI-RS resource identifiers of network entity 704 with those of network entity 708 and a second linkage scheme that can be used to associate SSB indices and/or CSI-RS resource identifiers of network entity 706 with those of network entity 708. In some aspects, different linkage schemes may be identified and/or otherwise associated with serving cell IDs (e.g., serving cell IDs corresponding to network entity 704, network entity 706, network entity 708, and/or network entity 710).

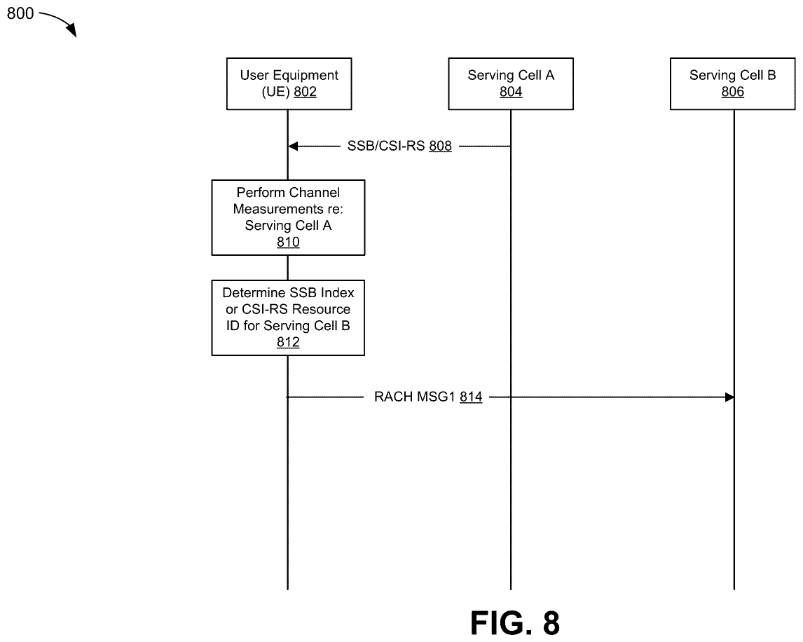

FIG. 8 is a sequence diagram illustrating an example of a sequence 800 for performing predictive beam management for secondary cell group (SCG) setup. The sequence 800 may be performed by user equipment (UE) 802, serving cell A 804, and serving cell B 806. In some aspects, serving cell A 804 may be part of a master cell group (MCG) and serving cell B 806 may be part of a secondary cell group (SCG). In some cases, the serving cell A 804 may be associated with a first network entity (e.g., a first gNB or portion thereof, such as a CU, DU, RU, etc. of the first gNB) and the serving cell B 806 may be associated with a second network entity (e.g., a second gNB or portion thereof, such as a CU, DU, RU, etc. of the second gNB). In some cases, the serving cell A 804 and the serving cell B 806 may be associated with a same network entity (e.g., a gNB or portion thereof, such as a CU, DU, RU, etc. of the gNB). In some examples, serving cell A 804 may be configured operate using a first frequency range (e.g., FR1, FR2, FR3, etc.) and serving cell B 806 may be configured to operate using an FR that is different from serving cell A 804.

At action 808, serving cell A 804 may transmit a sequence of synchronization signal block (SSB) beams or channel state information reference signal (CSI-RS) beams to UE 802. At action 810, UE 802 can perform channel measurements corresponding to the beams transmitted by serving cell A 804. In some aspect, the channel measurements can include reference signal received power (RSRP), received signal strength indicator (RSSI), reference signal quality (RSRQ), channel quality indicator (CQI), power delay profile (PDP), angle of arrival (AoA), angle of departure (AoD), angular spread, explicit time/frequency domain channel characteristics, Eigen vector(s) associated with the channel in the frequency domain, any combination thereof, and/or any other channel measurements.

At block 812, UE 802 can determine an SSB index and/or CSI-RS resource identifier associated with serving cell B 806. In some examples, UE 802 may identify the SSB index and/or the CSI-RS resource identifier associated with serving cell B 806 based on the channel measurements associated with serving cell A 804. For instance, UE 802 may be configured with linkage schemes that can be used to associate measurements obtained from serving cell A 804 with the SSB beams and/or CSI-RS beams corresponding to serving cell B 806. In some cases, the linkage schemes may be implemented using a machine learning model. In some examples, the linkage schemes may be explicitly configured. In some instances, a serving cell (e.g., serving cell A 804) may configure UE 802 to use linkage schemes (e.g., explicit linkage schemes and/or ML models).

At action 814, UE 802 may transmit an uplink signal to serving cell B 806 using a beam corresponding to the identified SSB index and/or the CSI-RS resource identifier. In some aspects, the uplink transmission may be used to initiate random access channel (RACH) procedures with serving cell B 806. For example, UE 802 may transmit a random access request message (e.g., Message 1 or Message A) to serving cell B 806.

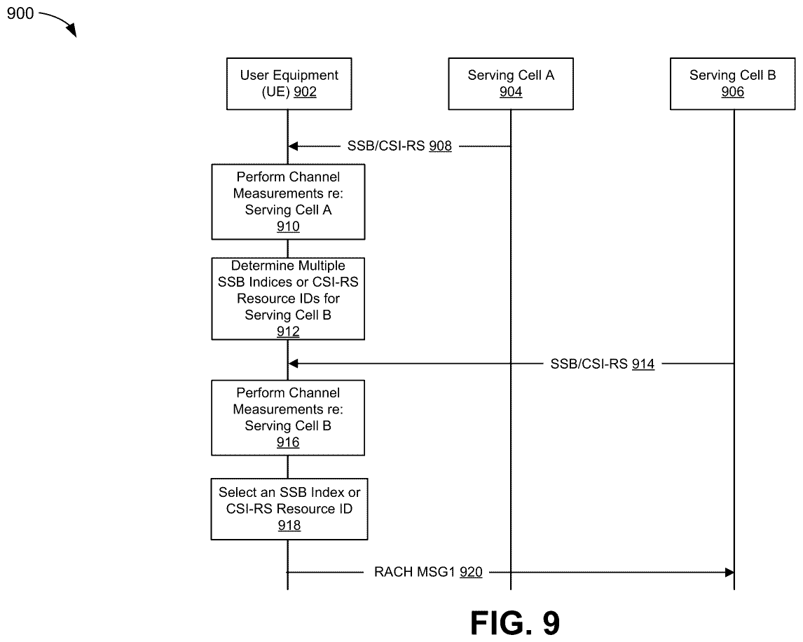

FIG. 9 is a sequence diagram illustrating an example of a sequence 900 for performing predictive beam management for secondary cell group (SCG) setup. The sequence 900 may be performed by user equipment (UE) 902, serving cell A 904, and serving cell B 906. In some aspects, serving cell A 904 may be part of a master cell group (MCG) and serving cell B 906 may be part of a secondary cell group (SCG). In some cases, the serving cell A 804 may be associated with a first network entity (e.g., a first gNB or portion thereof, such as a CU, DU, RU, etc. of the first gNB) and the serving cell B 806 may be associated with a second network entity (e.g., a second gNB or portion thereof, such as a CU, DU, RU, etc. of the second gNB). In some cases, the serving cell A 804 and the serving cell B 806 may be associated with a same network entity (e.g., a gNB or portion thereof, such as a CU, DU, RU, etc. of the gNB). In some examples, serving cell A 904 may be configured operate using a first frequency range (e.g., FR1, FR2, FR3, etc.) and serving cell B 906 may be configured to operate using an FR that is different from serving cell A 904.

At action 908, serving cell A 904 may transmit a sequence of synchronization signal block (SSB) beams or channel state information reference signal (CSI-RS) beams to UE 902. At action 910, UE 902 can perform channel measurements corresponding to the beams transmitted by serving cell A 904. In some aspect, the channel measurements can include reference signal received power (RSRP), received signal strength indicator (RSSI), reference signal quality (RSRQ), channel quality indicator (CQI), power delay profile (PDP), angle of arrival (AoA), angle of departure (AoD), angular spread, explicit time/frequency domain channel characteristics, Eigen vector(s) associated with the channel in the frequency domain, any combination thereof, and/or any other channel measurements.

At block 912, UE 902 can determine multiple SSB indices and/or CSI-RS resource identifiers associated with serving cell B 906. In some examples, UE 902 may identify the SSB indices and/or the CSI-RS resource identifiers associated with serving cell B 906 based on the channel measurements associated with serving cell A 904. For instance, UE 902 may be configured with linkage schemes that can be used to associate measurements obtained from serving cell A 904 with multiple SSB beams and/or CSI-RS beams corresponding to serving cell B 906. In some cases, the linkage schemes may be implemented using a machine learning model. In some examples, the linkage schemes may be explicitly configured. In some instances, a serving cell (e.g., serving cell A 904) may configure UE 902 to use linkage schemes (e.g., explicit linkage schemes and/or ML models).

At action 914, serving cell B 906 can transmit a sequence of synchronization signal block (SSB) beams or channel state information reference signal (CSI-RS) beams to UE 902. At action 916, UE 902 can perform channel measurements (e.g., RSRP, RSSI, AoA, AoD, etc.) corresponding to the beams associated with the identified SSB indices and/or the identified CSI-RS resource identifiers. At action 918, UE 902 can select a single SSB index and/or CSI-RS resource identifier based on the measurements.

At action 920, UE 902 may transmit an uplink signal to serving cell B 906 using a beam corresponding to the selected SSB index and/or the selected CSI-RS resource identifier. In some aspects, the uplink transmission may be used to initiate random access channel (RACH) procedures with serving cell B 906. For example, UE 902 may transmit a random access request message (e.g., Message 1 or Message A) to serving cell B 906.

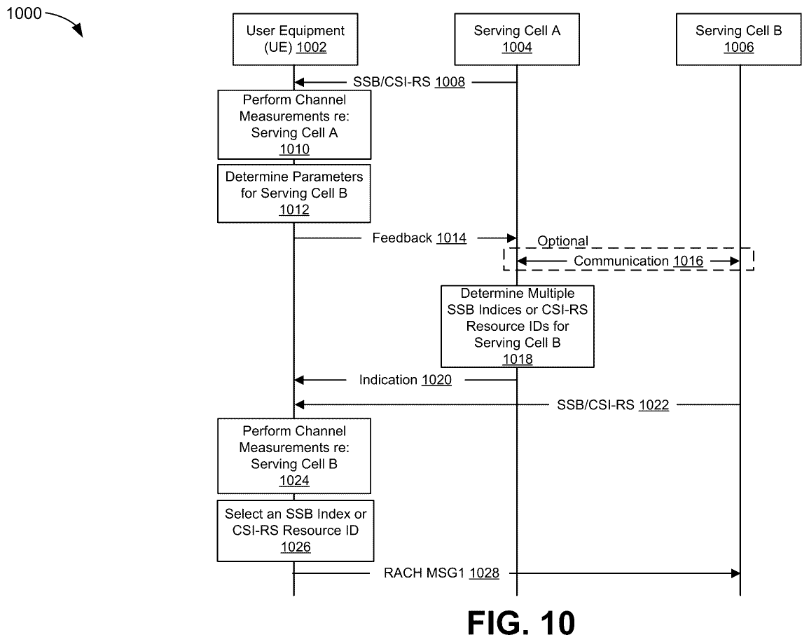

FIG. 10 is a sequence diagram illustrating an example of a sequence 1000 for performing predictive beam management for secondary cell group (SCG) setup. The sequence 1000 may be performed by user equipment (UE) 1002, serving cell A 1004, and serving cell B 1006. In some aspects, serving cell A 1004 may be part of a master cell group (MCG) and serving cell B 1006 may be part of a secondary cell group (SCG). In some cases, the serving cell A 804 may be associated with a first network entity (e.g., a first gNB or portion thereof, such as a CU, DU, RU, etc. of the first gNB) and the serving cell B 806 may be associated with a second network entity (e.g., a second gNB or portion thereof, such as a CU, DU, RU, etc. of the second gNB). In some cases, the serving cell A 804 and the serving cell B 806 may be associated with a same network entity (e.g., a gNB or portion thereof, such as a CU, DU, RU, etc. of the gNB). In some examples, serving cell A 1004 may be configured operate using a first frequency range (e.g., FR1, FR2, FR3, etc.) and serving cell B 1006 may be configured to operate using an FR that is different from serving cell A 1004.

At action 1008, serving cell A 1004 may transmit a sequence of synchronization signal block (SSB) beams or channel state information reference signal (CSI-RS) beams to UE 1002. At action 1010, UE 1002 can perform channel measurements corresponding to the beams transmitted by serving cell A 1004. In some aspect, the channel measurements can include reference signal received power (RSRP), received signal strength indicator (RSSI), reference signal quality (RSRQ), channel quality indicator (CQI), power delay profile (PDP), angle of arrival (AoA), angle of departure (AoD), angular spread, explicit time/frequency domain channel characteristics, Eigen vector(s) associated with the channel in the frequency domain, any combination thereof, and/or any other channel measurements.

At block 1012, UE 1002 can determine one or more parameters associated with serving cell B 1006. For instance, UE 1002 may be configured with linkage schemes that can be used to associate measurements obtained from serving cell A 1004 with parameters corresponding to serving cell B 1006. In some examples, UE 1002 may determine parameters such as AoA, AoD, angular spread, etc. corresponding to one or more beams associated with serving cell B 1006. At action 1014, UE 1002 may transmit a feedback message to serving cell A 1004. In some aspects, the feedback message can include the parameters that UE 1002 determined are associated with serving cell B 1006. In some cases, the feedback message can include the channel measurements obtained from signals transmitted by serving cell A 1004. In some examples, the feedback message may include serving cell identifiers (IDs) that are associated with parameters and/or measurements (e.g., UE 1002 may send feedback that includes parameters corresponding to multiple network entities).

At action 1016, serving cell A 1004 may optionally communicate with serving cell B 1006 to identify one or more SSB indices and/or CSI-RS resource identifiers for UE 1002 to communicate with serving cell B 1006. In some cases, serving cell A 1004 may transmit measurements and/or parameters obtained by UE 1002 to serving cell B 1006.

At action 1018, serving cell A 1004 can determine multiple SSB indices and/or CSI-RS resource identifiers associated with serving cell B 1006. In some examples, serving cell A 1004 may identify the SSB indices and/or the CSI-RS resource identifiers associated with serving cell B 1006 based on the channel measurements associated with serving cell A 1004. For instance, serving cell A 1004 may be configured with linkage schemes (e.g., explicit linkages and/or ML models) that can be used to associate measurements associated with serving cell A 1004 to multiple SSB beams and/or CSI-RS beams corresponding to serving cell B 1006. In some configurations, serving cell A 1004 may identify the SSB indices and/or the CSI-RS resource identifiers associated with serving cell B 1006 based on the parameters (e.g., AoA, AoD, angular spread) corresponding to serving cell B 1006 that are transmitted in the feedback message from UE 1002.

At action 1020, serving cell A 1004 can transmit an indication of the SSB indices and/or the CSI-RS resource identifiers to UE 1002. At action 1022, serving cell B 1006 can transmit a sequence of synchronization signal block (SSB) beams or channel state information reference signal (CSI-RS) beams to UE 1002. At action 1024, UE 1002 can perform channel measurements (e.g., RSRP, RSSI, AoA, AoD, etc.) for the beams corresponding to the identified SSB indices and/or the identified CSI-RS resource identifiers. At action 1026, UE 1002 can select a single SSB index and/or CSI-RS resource identifier based on the measurements.

At action 1028, UE 1002 may transmit an uplink signal to serving cell B 1006 using a beam corresponding to the selected SSB index and/or the selected CSI-RS resource identifier. In some aspects, the uplink transmission may be used to initiate random access channel (RACH) procedures with serving cell B 1006. For example, UE 1002 may transmit a random access request message (e.g., Message 1 or Message A) to serving cell B 1006.

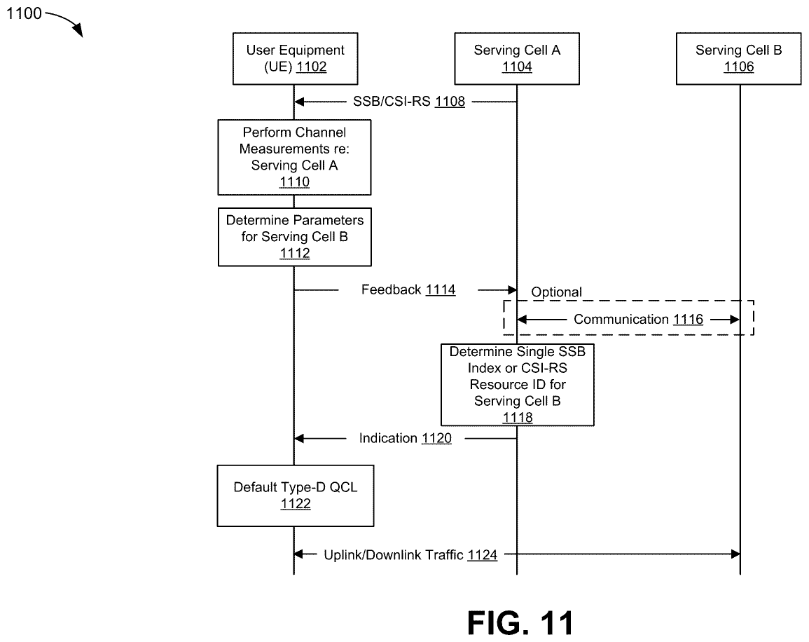

FIG. 11 is a sequence diagram illustrating an example of a sequence 1100 for performing predictive beam management for secondary cell group (SCG) setup. The sequence 1100 may be performed by user equipment (UE) 1102, serving cell A 1104, and serving cell B 1106. In some aspects, serving cell A 1104 may be part of a master cell group (MCG) and serving cell B 1106 may be part of a secondary cell group (SCG). In some cases, the serving cell A 804 may be associated with a first network entity (e.g., a first gNB or portion thereof, such as a CU, DU, RU, etc. of the first gNB) and the serving cell B 806 may be associated with a second network entity (e.g., a second gNB or portion thereof, such as a CU, DU, RU, etc. of the second gNB). In some cases, the serving cell A 804 and the serving cell B 806 may be associated with a same network entity (e.g., a gNB or portion thereof, such as a CU, DU, RU, etc. of the gNB). In some examples, serving cell A 1104 may be configured operate using a first frequency range (e.g., FR1, FR2, FR3, etc.) and serving cell B 1106 may be configured to operate using an FR that is different from serving cell A 1104.

At action 1108, serving cell A 1104 may transmit a sequence of synchronization signal block (SSB) beams or channel state information reference signal (CSI-RS) beams to UE 1102. At action 1110, UE 1102 can perform channel measurements corresponding to the beams transmitted by serving cell A 1104. In some aspect, the channel measurements can include reference signal received power (RSRP), received signal strength indicator (RSSI), reference signal quality (RSRQ), channel quality indicator (CQI), power delay profile (PDP), angle of arrival (AoA), angle of departure (AoD), angular spread, explicit time/frequency domain channel characteristics, Eigen vector(s) associated with the channel in the frequency domain, any combination thereof, and/or any other channel measurements.

At block 1112, UE 1102 can determine one or more parameters associated with serving cell B 1106. For instance, UE 1102 may be configured with linkage schemes that can be used to associate measurements obtained from serving cell A 1104 with parameters corresponding to serving cell B 1106. In some examples, UE 1102 may determine parameters such as AoA, AoD, angular spread, etc. corresponding to one or more beams associated with serving cell B 1106. At action 1114, UE 1102 may transmit a feedback message to serving cell A 1104. In some aspects, the feedback message can include the parameters that UE 1102 determined are associated with serving cell B 1106. In some cases, the feedback message can include the channel measurements obtained from signals transmitted by serving cell A 1104.

At action 1116, serving cell A 1104 may optionally communicate with serving cell B 1106 to identify one or more SSB indices and/or CSI-RS resource identifiers for UE 1102 to communicate with serving cell B 1106. In some cases, serving cell A 1104 may transmit measurements and/or parameters obtained by UE 1102 to serving cell B 1106.

At action 1118, serving cell A 1104 can determine a preferred SSB index and/or a preferred CSI-RS resource identifier that is associated with serving cell B 1106. In some examples, serving cell A 1104 may identify the preferred SSB index and/or the preferred CSI-RS resource identifier associated with serving cell B 1106 based on the channel measurements associated with serving cell A 1104. For instance, serving cell A 1104 may be configured with linkage schemes (e.g., explicit linkages and/or ML models) that can be used to associate measurements associated with serving cell A 1104 to a preferred SSB beam and/or a preferred CSI-RS beam corresponding to serving cell B 1106. In some configurations, serving cell A 1104 may identify the preferred SSB index and/or the preferred CSI-RS resource identifier associated with serving cell B 1106 based on the parameters (e.g., AoA, AoD, angular spread) corresponding to serving cell B 1106 that are transmitted in the feedback message from UE 1102.

At action 1120, serving cell A 1104 can transmit an indication of the preferred SSB index and/or the preferred CSI-RS resource identifier to UE 1102. In some examples, the indication may correspond to a transmission configuration indicator (TCI). In some aspects, the TCI may correspond to a virtual default state indicating that UE 1102 has successfully completed the radio access channel (RACH) procedure (e.g., through the corresponding preferred SSB or CSI-RS). In some examples, UE 1102 may bypass the RACH procedure with serving cell B 1106 when the timing advance (TA) associated with serving cell B 1106 is valid or less than a threshold value.

At action 1122, UE 1102 may configure a spatial receive filter based on a quasi co-location (QCL) type D parameter. In some aspects, the Type-D QCL parameter may be included in the indication (e.g., as part of TCI). In some cases, the Type D QCL may be used to direct a beam to a transmission beam from serving cell B 1106 that corresponds to the preferred SSB index and/or the preferred CSI-RS resource identifier.

At action 1124, UE 1102 may communicate (e.g., uplink and downlink) with serving cell B 1106. In some aspects, the uplink communication may include physical uplink shared channel (PUSCH) transmissions and the downlink communication may include physical downlink shared channel (PDSCH) transmissions.

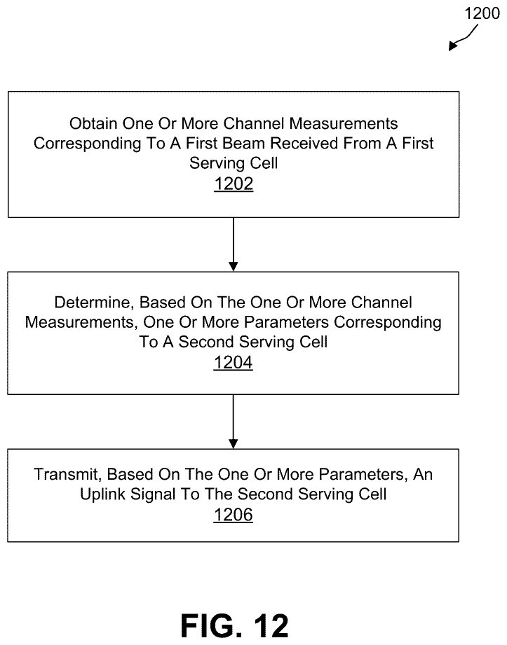

FIG. 12 is a flowchart diagram illustrating an example of a process 1200 for performing relay aircraft switching. In some aspects, process 1200 may be performed by a user equipment (UE), such as the UE 802 of FIG. 9, the UE 902 of FIG. 9, the UE 1002 of FIG. 10, the UE 1102 of FIG. 11, etc. At block 1202, the process 1200 includes obtaining one or more channel measurements corresponding to a first beam received from a first serving cell (e.g., serving cell A 804 of FIG. 8, serving cell A 904 of FIG. 9, serving cell A 1004 of FIG. 10, serving cell A 1104 of FIG. 11, etc.). In some aspects, the first beam is associated with a first frequency and the uplink signal is associated with a second frequency. In some cases, the first serving cell is associated with a master cell group (MCG) and the second serving cell is associated with a secondary cell group (SCG). In some examples, the one or more channel measurements include a reference signal received power (RSRP), a received signal strength indicator (RSSI), a reference signal quality (RSRQ), a power delay profile (PDP), an angle of arrival, a channel quality indicator (CQI), any combination thereof, and/or other channel measurements.

At block 1204, the process 1200 includes determining, based on the one or more channel measurements, one or more parameters corresponding to a second serving cell (e.g., serving cell B 806 of FIG. 8, serving cell B 906 of FIG. 9, serving cell B 1006 of FIG. 10, serving cell B 1106 of FIG. 11, etc.). In some aspects, the one or more parameters include an angle of arrival, an angle of departure, an angular spread, a synchronization signal block (SSB) index, a channel state information reference signal (CSI-RS) resource identifier, any combination thereof, and/or other parameters. In some cases, the first serving cell may be associated with a first network entity (e.g., a first gNB or portion thereof, such as a CU, DU, RU, etc. of the first gNB) and the second serving cell may be associated with a second network entity (e.g., a second gNB or portion thereof, such as a CU, DU, RU, etc. of the second gNB). In some cases, the first serving cell and the second serving cell may be associated with a same network entity (e.g., a gNB or portion thereof, such as a CU, DU, RU, etc. of the gNB).

In some aspects, the process 1200 may determine the one or more parameters corresponding to the second serving cell based on a linkage between the one or more channel measurements corresponding to the first beam and the one or more parameters corresponding to the second serving cell. In some cases, the linkage is based on a table or function that maps the one or more channel measurements corresponding to the first beam to the one or more parameters corresponding to the second serving cell. In some examples, the linkage may be explicitly configured on the UE (e.g., a table or function that maps measurements from the first serving cell to parameters corresponding to the second serving cell). In some examples, the linkage may be implemented using one or more machine learning algorithms. For example, a machine learning model can receive input that includes one or more channel measurements from a first serving cell and provide an output that includes one or more parameters corresponding to a second serving cell.

At block 1206, the process 1200 includes transmitting, based on the one or more parameters, an uplink signal to the second serving cell. In some aspects, the uplink signal includes a random access channel (RACH) message.

In some aspects, the process 1200 may include identifying, based on the one or more parameters, a plurality of beams associated with the second serving cell. The process 1200 may include obtaining at least one channel measurement corresponding to the plurality of beams and selecting (e.g., based on the at least one channel measurement corresponding to the plurality of beams) at least one beam from the plurality of beams for transmitting the uplink signal to the second serving cell.

In some examples, the process 1200 may include transmitting the one or more parameters to the first serving cell. The process 1200 may include receiving, from the first serving cell, an indication of a plurality of beams associated with the second serving cell, wherein the indication is based on the one or more parameters. The process 1200 may include obtaining at least one channel measurement corresponding to the plurality of beams and selecting (e.g., based on the at least one channel measurement corresponding to the plurality of beams) at least one beam from the plurality of beams for transmitting the uplink signal to the second serving cell.

In some cases, the process 1200 may include transmitting the one or more parameters to the first serving cell. The process 1200 may include receiving, from the first serving cell, an indication of a preferred beam associated with the second serving cell. The indication is based on the one or more parameters. The process 1200 may include selecting (e.g., based on the indication) the preferred beam for transmitting the uplink signal to the second serving cell.

In some aspects, the process 1200 may include determining, based on the one or more channel measurements, one or more additional parameters corresponding to a third serving cell. In some cases, the process 1200 may include transmitting the one or more additional parameters and a corresponding cell identifier associated with the third serving cell to the first serving cell.

In some cases, the process 1200 may include obtaining one or more additional channel measurements corresponding to a second beam received from a third serving cell. In some examples, the first beam and the second beam are associated with different frequencies.

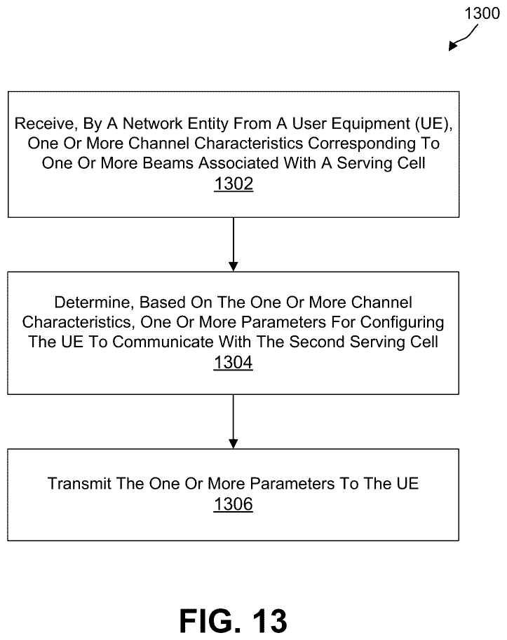

FIG. 13 is a flowchart diagram illustrating an example of a process 1300 for performing relay aircraft switching. In some aspects, process 1300 may be performed by a network entity, such as the base station 102 of FIG. 2, the RU 340 of FIG. 3, the DU 330 of FIG. 3, and/or the CU 310 of FIG. 3. At block 1302, the process 1300 includes receiving, from a user equipment (UE), one or more channel characteristics corresponding to one or more beams associated with a serving cell. In some cases, the apparatus operates using a first frequency, and the one or more beams are associated with a second frequency for communicating with the network entity. In some aspects, the network entity (e.g., a first gNB) may be associated with a first serving cell and the second serving cell may be associated with a second network entity (e.g., a second gNB or portion thereof, such as a CU, DU, RU, etc. of the second gNB). In some cases, the network entity may be associated with the first serving cell and the second serving cell.

At block 1304, the process 1300 includes determining, based on the one or more channel characteristics, one or more parameters for configuring the UE to communicate with the serving cell. In some aspects, the one or more parameters include a synchronization signal block (SSB) index, a channel state information reference signal (CSI-RS) resource identifier, a transmission configuration indication (TCI), any combination thereof, and/or other parameters.

At block 1306, the process 1300 includes transmitting the one or more parameters to the UE. In some aspects, the process 1300 includes transmitting one or more configurations to the UE. For instance, the one or more configurations may correspond to a linkage between the one or more channel measurements corresponding to the one or more beams associated with a serving cell and the one or more parameters for configuring the UE to communicate with the serving cell. In some cases, the linkage is based on a table or function that maps the one or more channel measurements to the one or more parameters. In some examples, the linkage may be explicitly configured on the UE (e.g., a table or function that maps measurements from the first serving cell to parameters corresponding to the second serving cell). In some examples, the linkage may be implemented using one or more machine learning algorithms. For instance, a machine learning model can receive input that includes one or more channel measurements from a first serving cell and provide an output that includes one or more parameters corresponding to a second serving cell. In one illustrative example, the configuration may correspond to one or more machine learning models for determining the one or more channel characteristics by the UE based on one or more measurements corresponding to at least one beam transmitted by the network entity.

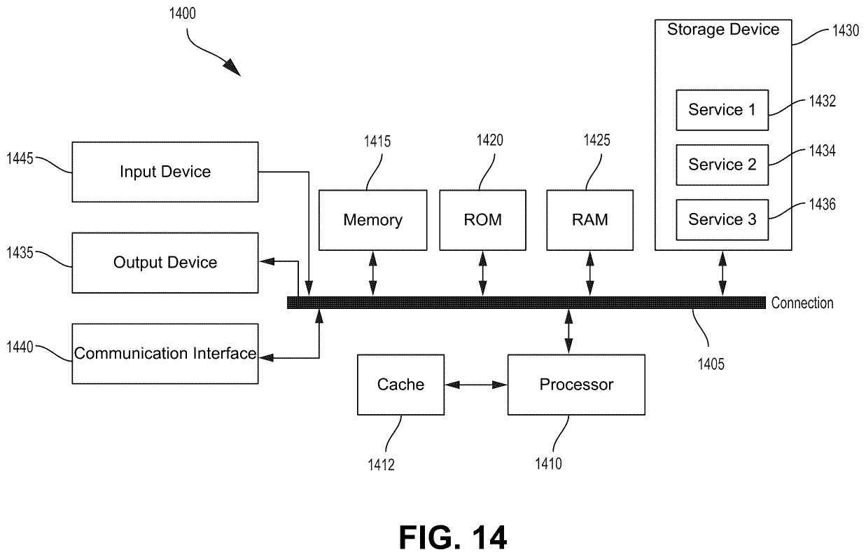

In some examples, the processes described herein (e.g., process 1200, process 1300, and/or other process described herein) may be performed by a computing device or apparatus (e.g., a UE or a base station). In one example, the process 1200 can be performed by the UE 104 of FIG. 2, the UE 802 of FIG. 9, the UE 902 of FIG. 9, the UE 1002 of FIG. 10, the UE 1102 of FIG. 11, etc. In another example, the process 1300 can be performed by a network entity, such as the base station 102 of FIG. 2, the RU 340 of FIG. 3, the DU 330 of FIG. 3, and/or the CU 310 of FIG. 3. In another example, the process 1200 and the process 1300 may be performed by a computing device with the computing system 1400 shown in FIG. 14.

In some cases, the computing device or apparatus may include various components, such as one or more input devices, one or more output devices, one or more processors, one or more microprocessors, one or more microcomputers, one or more cameras, one or more sensors, and/or other component(s) that are configured to carry out the steps of processes described herein. In some examples, the computing device may include a display, one or more network interfaces configured to communicate and/or receive the data, any combination thereof, and/or other component(s). The one or more network interfaces can be configured to communicate and/or receive wired and/or wireless data, including data according to the 3G, 4G, 5G, and/or other cellular standard, data according to the Wi-Fi (802.11x) standards, data according to the Bluetooth™ standard, data according to the Internet Protocol (IP) standard, and/or other types of data.

The components of the computing device can be implemented in circuitry. For example, the components can include and/or can be implemented using electronic circuits or other electronic hardware, which can include one or more programmable electronic circuits (e.g., microprocessors, neural processing units (NPUs), graphics processing units (GPUs), digital signal processors (DSPs), central processing units (CPUs), and/or other suitable electronic circuits), and/or can include and/or be implemented using computer software, firmware, or any combination thereof, to perform the various operations described herein.

The process 1200 and process 1300 are illustrated as logical flow diagrams, the operation of which represents a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, process 1200, process 1300, and/or other processes described herein may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program comprising a plurality of instructions executable by one or more processors. The computer-readable or machine-readable storage medium may be non-transitory.

FIG. 14 is a diagram illustrating an example of a system for implementing certain aspects of the present technology. In particular, FIG. 14 illustrates an example of computing system 1400, which may be for example any computing device making up internal computing system, a remote computing system, a camera, or any component thereof in which the components of the system are in communication with each other using connection 1405. Connection 1405 may be a physical connection using a bus, or a direct connection into processor 1410, such as in a chipset architecture. Connection 1405 may also be a virtual connection, networked connection, or logical connection.

In some embodiments, computing system 1400 is a distributed system in which the functions described in this disclosure may be distributed within a datacenter, multiple data centers, a peer network, etc. In some embodiments, one or more of the described system components represents many such components each performing some or all of the function for which the component is described. In some embodiments, the components may be physical or virtual devices.

Example system 1400 includes at least one processing unit (CPU or processor) 1410 and connection 1405 that communicatively couples various system components including system memory 1415, such as read-only memory (ROM) 1420 and random access memory (RAM) 1425 to processor 1410. Computing system 1400 may include a cache 1412 of high-speed memory connected directly with, in close proximity to, or integrated as part of processor 1410.

Processor 1410 may include any general purpose processor and a hardware service or software service, such as services 1432, 1434, and 1436 stored in storage device 1430, configured to control processor 1410 as well as a special-purpose processor where software instructions are incorporated into the actual processor design. Processor 1410 may essentially be a completely self-contained computing system, containing multiple cores or processors, a bus, memory controller, cache, etc. A multi-core processor may be symmetric or asymmetric.

To enable user interaction, computing system 1400 includes an input device 1445, which may represent any number of input mechanisms, such as a microphone for speech, a touch-sensitive screen for gesture or graphical input, keyboard, mouse, motion input, speech, etc. Computing system 1400 may also include output device 1435, which may be one or more of a number of output mechanisms. In some instances, multimodal systems may enable a user to provide multiple types of input/output to communicate with computing system 1400.

Computing system 1400 may include communications interface 1440, which may generally govern and manage the user input and system output. The communication interface may perform or facilitate receipt and/or transmission wired or wireless communications using wired and/or wireless transceivers, including those making use of an audio jack/plug, a microphone jack/plug, a universal serial bus (USB) port/plug, an Apple™ Lightning™ port/plug, an Ethernet port/plug, a fiber optic port/plug, a proprietary wired port/plug, 3G, 4G, 5G and/or other cellular data network wireless signal transfer, a Bluetooth™ wireless signal transfer, a Bluetooth™ low energy (BLE) wireless signal transfer, an IBEACON™ wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof. The communications interface 1440 may also include one or more Global Navigation Satellite System (GNSS) receivers or transceivers that are used to determine a location of the computing system 1400 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 1430 may be a non-volatile and/or non-transitory and/or computer-readable memory device and may be a hard disk or other types of computer readable media which may store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (e.g., Level 1 (L1) cache, Level 2 (L2) cache, Level 3 (L3) cache, Level 4 (L4) cache, Level 5 (L5) cache, or other (L #) cache), resistive random-access memory (RRAM/ReRAM), phase change memory (PCM), spin transfer torque RAM (STT-RAM), another memory chip or cartridge, and/or a combination thereof.

The storage device 1430 may include software services, servers, services, etc., that when the code that defines such software is executed by the processor 1410, it causes the system to perform a function. In some embodiments, a hardware service that performs a particular function may include the software component stored in a computer-readable medium in connection with the necessary hardware components, such as processor 1410, connection 1405, output device 1435, etc., to carry out the function. The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data may be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

Specific details are provided in the description above to provide a thorough understanding of the embodiments and examples provided herein, but those skilled in the art will recognize that the application is not limited thereto. Thus, while illustrative embodiments of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, embodiments can be utilized in any number of environments and applications beyond those described herein without departing from the broader scope of the specification. The specification and drawings are, accordingly, to be regarded as illustrative rather than restrictive. For the purposes of illustration, methods were described in a particular order. It should be appreciated that in alternate embodiments, the methods may be performed in a different order than that described.

For clarity of explanation, in some instances the present technology may be presented as including individual functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

Individual embodiments may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general purpose computer, special purpose computer, or a processing device to perform a certain function or group of functions. Portions of computer resources used can be accessible over a network. The computer executable instructions may be, for example, binaries, intermediate format instructions such as assembly language, firmware, source code. Examples of computer-readable media that may be used to store instructions, information used, and/or information created during methods according to described examples include magnetic or optical disks, flash memory, USB devices provided with non-volatile memory, networked storage devices, and so on.

In some embodiments the computer-readable storage devices, mediums, and memories can include a cable or wireless signal containing a bitstream and the like. However, when mentioned, non-transitory computer-readable storage media expressly exclude media such as energy, carrier signals, electromagnetic waves, and signals per se.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof, in some cases depending in part on the particular application, in part on the desired design, in part on the corresponding technology, etc.

The various illustrative logical blocks, modules, and circuits described in connection with the aspects disclosed herein may be implemented or performed using hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods, algorithms, and/or operations described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” or “communicatively coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B.

Illustrative aspects of the disclosure include:

Aspect 1. A method for wireless communications performed at a user equipment (UE), comprising: obtaining one or more channel measurements corresponding to a first beam received from a first serving cell; determining, based on the one or more channel measurements, one or more parameters corresponding to a second serving cell; and transmitting, based on the one or more parameters, an uplink signal to the second serving cell.

Aspect 2. The method of Aspect 1, wherein the first beam is associated with a first frequency and the uplink signal is associated with a second frequency.

Aspect 3. The method of any of Aspects 1 to 2, wherein the first serving cell is associated with a master cell group (MCG) and the second serving cell is associated with a secondary cell group (SCG).

Aspect 4. The method of any of Aspects 1 to 3, wherein the first beam includes at least one of a synchronization signal block (SSB) and a channel state information reference signal (CSI-RS).

Aspect 5. The method of any of Aspects 1 to 4, wherein the one or more channel measurements include at least one of a reference signal received power (RSRP), a received signal strength indicator (RSSI), a reference signal quality (RSRQ), a power delay profile (PDP), an angle of arrival, and a channel quality indicator (CQI).

Aspect 6. The method of any of Aspects 1 to 5, wherein the one or more parameters include at least one of an angle of arrival, an angle of departure, an angular spread, a synchronization signal block (SSB) index, and a channel state information reference signal (CSI-RS) resource identifier.

Aspect 7. The method of any of Aspects 1 to 6, wherein the uplink signal includes a random access channel (RACH) message.

Aspect 8. The method of any of Aspects 1 to 7, further comprising: identifying, based on the one or more parameters, a plurality of beams associated with the second serving cell; obtaining at least one channel measurement corresponding to the plurality of beams; and selecting at least one beam from the plurality of beams for transmitting the uplink signal to the second serving cell.

Aspect 9. The method of Aspects 8, wherein the plurality of beams each correspond to at least one of a first set of resources associated with a synchronization signal block (SSB) and a second set of resources associated with a channel state information reference signal (CSI-RS).

Aspect 10. The method of any of Aspects 1 to 9, further comprising: transmitting the one or more parameters to the first serving cell; receiving, from the first serving cell, an indication of a plurality of beams associated with the second serving cell, wherein the indication is based on the one or more parameters; obtaining at least one channel measurement corresponding to the plurality of beams; and selecting at least one beam from the plurality of beams for transmitting the uplink signal to the second serving cell.

Aspect 11. The method of any of Aspects 1 to 10, further comprising: transmitting the one or more parameters to the first serving cell; receiving, from the first serving cell, an indication of a preferred beam associated with the second serving cell, wherein the indication is based on the one or more parameters; and selecting the preferred beam for transmitting the uplink signal to the second serving cell.

Aspect 12. The method of Aspect 11, further comprising: configuring, based on a default spatial receive parameter, a spatial receive filter corresponding to the preferred beam.

Aspect 13. The method of any of Aspects 11 to 12, wherein the uplink signal includes a physical uplink shared channel (PUSCH) transmission.

Aspect 14. The method of any of Aspects 11 to 13, wherein the indication corresponds to a transmission configuration indication (TCI).

Aspect 15. The method of any of Aspects 1 to 14, wherein the one or more parameters correspond to the second serving cell and a third serving cell.

Aspect 16. The method of any of Aspects 1 to 15, further comprising: transmitting at least a portion of the one or more parameters to the first serving cell, wherein the portion is configured by the first serving cell.

Aspect 17. The method of any of Aspects 1 to 16, further comprising: determining, based on the one or more channel measurements, one or more additional parameters corresponding to a third serving cell.

Aspect 18. The method of Aspect 17, further comprising: transmitting the one or more additional parameters and a corresponding cell identifier associated with the third serving cell to the first serving cell.

Aspect 19. The method of any of Aspects 1 to 18, further comprising: obtaining one or more additional channel measurements corresponding to a second beam received from a third serving cell.

Aspect 20. The method of Aspect 19, wherein the first beam and the second beam are associated with different frequencies.

Aspect 21. The method of any of Aspects 19 to 20, wherein the one or more parameters are further based on the one or more additional channel measurements.

Aspect 22. The method of any of Aspects 19 to 21, further comprising: determining, based on the one or more additional channel measurements, one or more additional parameters corresponding to the second serving cell.

Aspect 23. The apparatus of any of Aspects 1 to 22, wherein the at least one processor is configured to determine the one or more parameters corresponding to the second serving cell based on a linkage between the one or more channel measurements corresponding to the first beam and the one or more parameters corresponding to the second serving cell.

Aspect 24. The apparatus of Aspect 23, wherein the linkage is based on a table or function that maps the one or more channel measurements corresponding to the first beam to the one or more parameters corresponding to the second serving cell.

Aspect 25. An apparatus for wireless communications, comprising: at least one memory; and at least one processor coupled to the at least one memory, wherein the at least one processor is configured to perform operations in accordance with any one of Aspects 1-24.

Aspect 26. An apparatus for wireless communications, comprising means for performing operations in accordance with any one of Aspects 1 to 24.

Aspect 27. A non-transitory computer-readable medium comprising instructions that, when executed by an apparatus, cause the apparatus to perform operations in accordance with any one of Aspects 1 to 24.

Aspect 28. A method for wireless communications performed at a first serving cell, comprising: receiving, from a user equipment (UE), one or more channel characteristics corresponding to one or more beams associated with a second serving cell; determining, based on the one or more channel characteristics, one or more parameters for configuring the UE to communicate with the second serving cell; and transmitting the one or more parameters to the UE.

Aspect 29. The method of Aspect 28, wherein the one or more channel characteristics include at least one of an angle of arrival, an angle of departure, and an angular spread.

Aspect 30. The method of any of Aspects 28 to 29, wherein the one or more parameters include at least one of a synchronization signal block (SSB) index, a channel state information reference signal (CSI-RS) resource identifier, and a transmission configuration indication (TCI).

Aspect 31. The method of any of Aspects 28 to 30, further comprising: transmitting one or more configurations to the UE, wherein the one or more configurations correspond to machine learning models for determining the one or more channel characteristics by the UE based on one or more measurements corresponding to at least one beam transmitted by the first serving cell.

Aspect 32. The method of any of Aspects 28 to 31, wherein the first serving cell operates using a first frequency, and wherein the one or more beams are associated with a second frequency for communicating with the second serving cell.

Aspect 33. An apparatus for wireless communications, comprising: at least one memory; and at least one processor coupled to the at least one memory, wherein the at least one processor is configured to perform operations in accordance with any one of Aspects 28-32.

Aspect 34. An apparatus for wireless communications, comprising means for performing operations in accordance with any one of Aspects 28-32.

Aspect 35. A non-transitory computer-readable medium comprising instructions that, when executed by an apparatus, cause the apparatus to perform operations in accordance with any one of Aspects 28-32.

What is claimed is:

1. An apparatus for wireless communications, comprising:
at least one memory comprising instructions; and
at least one processor configured to execute the instructions and cause the apparatus to:
obtain one or more channel measurements corresponding to a first beam received from a first serving cell;
determine, based on the one or more channel measurements, one or more parameters corresponding to a second serving cell; and
transmit, based on the one or more parameters, an uplink signal to the second serving cell.

2. The apparatus of claim 1, wherein the at least one processor is configured to determine the one or more parameters corresponding to the second serving cell based on a linkage between the one or more channel measurements corresponding to the first beam and the one or more parameters corresponding to the second serving cell.

3. The apparatus of claim 2, wherein the linkage is based on a table or function that maps the one or more channel measurements corresponding to the first beam to the one or more parameters corresponding to the second serving cell.

4. The apparatus of claim 1, wherein the first beam is associated with a first frequency and the uplink signal is associated with a second frequency.

5. The apparatus of claim 1, wherein the first serving cell is associated with a master cell group (MCG) and the second serving cell is associated with a secondary cell group (SCG).

6. The apparatus of claim 1, wherein the one or more channel measurements include at least one of a reference signal received power (RSRP), a received signal strength indicator (RSSI), a reference signal quality (RSRQ), a power delay profile (PDP), an angle of arrival, and a channel quality indicator (CQI).

7. The apparatus of claim 1, wherein the one or more parameters include at least one of an angle of arrival, an angle of departure, an angular spread, a synchronization signal block (SSB) index, and a channel state information reference signal (CSI-RS) resource identifier.

8. The apparatus of claim 1, wherein the uplink signal includes a random access channel (RACH) message.

9. The apparatus of claim 1, wherein the at least one processor is further configured to cause the apparatus to:
identify, based on the one or more parameters, a plurality of beams associated with the second serving cell;
obtain at least one channel measurement corresponding to the plurality of beams; and
select at least one beam from the plurality of beams for transmitting the uplink signal to the second serving cell.

10. The apparatus of claim 1, wherein the at least one processor is further configured to cause the apparatus to:
transmit the one or more parameters to the first serving cell;
receive, from the first serving cell, an indication of a plurality of beams associated with the second serving cell, wherein the indication is based on the one or more parameters;
obtain at least one channel measurement corresponding to the plurality of beams; and
select at least one beam from the plurality of beams for transmitting the uplink signal to the second serving cell.

11. The apparatus of claim 1, wherein the at least one processor is further configured to cause the apparatus to:
transmit the one or more parameters to the first serving cell;
receive, from the first serving cell, an indication of a preferred beam associated with the second serving cell, wherein the indication is based on the one or more parameters; and
select the preferred beam for transmitting the uplink signal to the second serving cell.

12. The apparatus of claim 1, wherein the at least one processor is further configured to cause the apparatus to:
determine, based on the one or more channel measurements, one or more additional parameters corresponding to a third serving cell.

13. The apparatus of claim 12, wherein the at least one processor is further configured to cause the apparatus to:
transmit the one or more additional parameters and a corresponding cell identifier associated with the third serving cell to the first serving cell.

14. The apparatus of claim 1, wherein the at least one processor is further configured to cause the apparatus to:
obtain one or more additional channel measurements corresponding to a second beam received from a third serving cell.

15. The apparatus of claim 14, wherein the first beam and the second beam are associated with different frequencies.

16. A method for wireless communications performed at a user equipment (UE), comprising:
obtaining one or more channel measurements corresponding to a first beam received from a first serving cell;
determining, based on the one or more channel measurements, one or more parameters corresponding to a second serving cell; and
transmitting, based on the one or more parameters, an uplink signal to the second serving cell.

17. The method of claim 16, wherein the one or more parameters corresponding to the second serving cell are determined based on a linkage between the one or more channel measurements corresponding to the first beam and the one or more parameters corresponding to the second serving cell, and wherein the linkage is based on a table or function that maps the one or more channel measurements corresponding to the first beam to the one or more parameters corresponding to the second serving cell.

18. The method of claim 16, wherein the first beam is associated with a first frequency and the uplink signal is associated with a second frequency.

19. The method of claim 16, wherein the first serving cell is associated with a master cell group (MCG) and the second serving cell is associated with a secondary cell group (SCG).

20. The method of claim 16, wherein the one or more channel measurements include at least one of a reference signal received power (RSRP), a received signal strength indicator (RSSI), a reference signal quality (RSRQ), a power delay profile (PDP), an angle of arrival, and a channel quality indicator (CQI).

21. The method of claim 16, wherein the one or more parameters include at least one of an angle of arrival, an angle of departure, an angular spread, a synchronization signal block (SSB) index, and a channel state information reference signal (CSI-RS) resource identifier.

22. The method of claim 16, wherein the uplink signal includes a random access channel (RACH) message.

23. The method of claim 16, further comprising:
identifying, based on the one or more parameters, a plurality of beams associated with the second serving cell;
obtaining at least one channel measurement corresponding to the plurality of beams; and
selecting at least one beam from the plurality of beams for transmitting the uplink signal to the second serving cell.

24. The method of claim 16, further comprising:
transmitting the one or more parameters to the first serving cell;
receiving, from the first serving cell, an indication of a plurality of beams associated with the second serving cell, wherein the indication is based on the one or more parameters;
obtaining at least one channel measurement corresponding to the plurality of beams; and
selecting at least one beam from the plurality of beams for transmitting the uplink signal to the second serving cell.

25. The method of claim 16, further comprising:
transmitting the one or more parameters to the first serving cell;
receiving, from the first serving cell, an indication of a preferred beam associated with the second serving cell, wherein the indication is based on the one or more parameters; and
selecting the preferred beam for transmitting the uplink signal to the second serving cell.

26. The method of claim 16, further comprising:
determining, based on the one or more channel measurements, one or more additional parameters corresponding to a third serving cell.

27. The method of claim 26, further comprising:
transmitting the one or more additional parameters and a corresponding cell identifier associated with the third serving cell to the first serving cell.

28. The method of claim 16, further comprising:
obtaining one or more additional channel measurements corresponding to a second beam received from a third serving cell.

29. The method of claim 28, wherein the first beam and the second beam are associated with different frequencies.

30. An apparatus for wireless communications, comprising:
at least one memory comprising instructions; and
at least one processor configured to execute the instructions and cause the apparatus to:
receive, from a user equipment (UE), one or more channel characteristics corresponding to one or more beams associated with a serving cell;
determine, based on the one or more channel characteristics, one or more parameters for configuring the UE to communicate with the serving cell; and
transmit the one or more parameters to the UE.
